(19) United States
(12) Patent Application Publication
(10) Pub. No.: US 2011/0042324 A1
(43) Pub. Date: Feb. 24, 2011

(54) SYSTEM AND METHOD FOR WATER RESTORATION

(76) Inventor: Matthew Hughes, Chandler, AZ (US)

Correspondence Address: BLACK LOWE & GRAHAM, PLLC, 701 FIFTH AVENUE, SUITE 4800, SEATTLE, WA, 98104, US

(21) Appl. No.: 12/888,320

(22) Filed: Sep. 22, 2010

Related U.S. Application Data
(63) Continuation-in-part of application No. 12/489,350, filed on Jun. 22, 2009, now Pat. No. 7,824,555.
Application No. 12/489,350 is a continuation of application No. 11/678,437, filed on Feb. 23, 2007, now Pat. No. 7,550,079.
(60) Provisional application No. 60/887,873, filed on Feb. 2, 2007.

(51) Int. Cl. C02F 1/40; E02B 15/10

(52) U.S. Cl. 210/747; 210/170.09; 210/170.11

(57) ABSTRACT

A polarized distribution of positive flow sources are deployed to at least partially circumscribe one side of an oily patch floating in a water region and negative flow sources deployed to at least partially circumscribe the other side of the oily patch. Water emanates near the water line level from the positive flow sources and water is aspirated near the water line level by the negative flow sources, both water emanation and aspiration collaboratively causing the oily patch to move from the positive flow source side towards the negative flow source side. Aspirated water surfaces containing the oily patch are processed to separate oil from water and return the water to the water region. The positive and negative flow sources may be deployed near a boat slip, a marina, an oil rig platform, or in open water between boats, and may be supported by floatation devices.

### CROSS REFERENCE TO RELATED APPLICATIONS

This application is a continuation-in-part of and incorporates by reference in its entirety U.S. patent application Ser. No. 12/489,350 filed Jun. 22, 2009 which is a continuation of and incorporates by reference in its entirety International Patent Application Serial No. PCTUS07062808 filed Feb. 26, 2007 and U.S. patent application Ser. No. 11/678,437 filed Feb. 23, 2007 that in turn claims the benefit of priority to and incorporates by reference in its entirety U.S. Provisional Patent Application Ser. No. 60/887,873 filed Feb. 2, 2007. All applications are incorporated by reference in their entirety.

### FIELD OF THE INVENTION

An embodiment of the invention relates generally to water restoration.

### BACKGROUND OF THE INVENTION

Boats, ships, or other marine vessels transiting to or housed in slips located in freshwater or ocean water marinas oftentimes contaminate the marina water with oil, gasoline, diesel and other hydrocarbon-based wastes by virtue of vessel use, or as a result of spills and vessel deterioration. Removing hydrocarbon-based and other pollutant wastes helps in the restoration of marina water or open water sources.

### BRIEF DESCRIPTION OF THE DRAWINGS

Embodiments of the present invention are described in detail below with reference to the following drawings.

FIG. 1 schematically and pictorially illustrates a water restoration system 10A connected with an inverted U-shaped marina showing the movement of marina water from a positive flow source to a negative flow source between adjacently opposed boat slips;

FIG. 2 schematically and pictorially illustrates an alternate embodiment of a water restoration system 10B connected with an inverted U-shaped marina showing the movement of marina water from a positive flow source to a negative flow source between adjacently opposed boat slips;

FIG. 3 schematically and pictorially illustrates an alternate embodiment of a water restoration system 10C connected with an inverted U-shaped marina showing the movement of marina water from a positive flow source to a negative flow source between adjacently opposed boat slips;

FIG. 4 schematically and pictorially illustrates an alternate embodiment of a water restoration system 10D connected with an inverted U-shaped marina showing the movement of marina water from a positive flow source to a negative flow source between adjacently opposed boat slips;

FIG. 5 schematically and pictorially illustrates an alternate embodiment of a water restoration system 10E connected with an I-shaped marina showing the movement of marina water from a positive flow source to a negative flow source between adjacently located boat slips;

FIG. 6 schematically and pictorially illustrates an alternate embodiment of a water restoration system 10F connected with an I-shaped marina showing the movement of marina water from a positive flow source to a negative flow source between adjacently located boat slips;

FIG. 7 is a partial cross section and side view of the opposing boat slips of the inverted U-shaped marina of FIG. 1;

FIG. 8 is an expanded top view of the suction port 24 slidably engaged with the rails 72 of FIG. 7;

FIG. 9 is an expanded top view of the water jet 20 slidably engaged with the rail 82 of FIG. 7;

FIG. 10 is an expanded side view of an alternate embodiment of the suction port 24 slidably engaged with the rails 72 of FIG. 7;

FIG. 11 is an expanded top view of an alternate, pivotable embodiment of the suction port 24 slidably engaged with the rails 72 of FIG. 7;

FIG. 12 is an expanded side perspective view of the water jets 20 and 32 slidably engaged with the rail 82 via jet nozzle holder 140 assembly providing a vertical, rotation, and tilt movements;

FIG. 13 is an expanded side view of the water jet 20 slidably engaged with the rail 82 of FIG. 12;

FIG. 14 schematically illustrates a water restoration system 100 for a multi-slip marina that is an expansion of the inverted U-shaped two-slip marina of FIG. 4;

FIG. 15 schematically and pictorially illustrates the plumbing configuration of the marina negative flow sources of water restoration system 100 of FIG. 14;

FIG. 16 schematically and pictorially illustrates the plumbing configuration of the marina positive flow sources of water restoration system 100 of FIG. 14;

FIG. 17 schematically illustrates a top view of an alternate embodiment of a tanker ship oil spill containment system 300 showing exemplary surface water flow patterns in a boat slip berthed with a large oil tanker ship;

FIG. 18 schematically illustrates a top view of the positive pressure hydraulic loop 310 and negative pressure hydraulic loop 350 of the tanker ship oil spill containment system 300 showing exemplary surface water flow patterns in the boat slip without the large oil tanker ship being present;

FIG. 19A schematically illustrates a side view of the positive hydraulic loop 310 of the tanker ship oil spill containment system 300;

FIG. 19B schematically illustrates a cross-sectional view along line A-A of pipe 312 of the positive hydraulic loop 310;

FIG. 19C schematically illustrates a cross-sectional and side view along line A-A of FIG. 19A of the out flow aperture 324;

FIG. 20 schematically illustrates a side view of a positive floating boom or floatable pipe 312 of the positive hydraulic loop 310 fitted with an hydraulic jet 330;

FIG. 21 schematically illustrates a cross-sectional view along line B-B through the hydraulic jet 330 of positive floating boom 320 of the positive hydraulic loop 310;

FIG. 22A schematically illustrates a side view of the negative hydraulic loop 350 of the tanker ship oil spill containment system 300;

FIG. 22B schematically illustrates a cross-sectional view along line C-C of pipe 352 of the negative hydraulic loop 350;

FIG. 22C schematically illustrates a cross-sectional and side view along line C-C of FIG. 22A of the aperture 364;

FIG. 23 schematically illustrates a side view of the negative floating boom 352 of the negative hydraulic loop 330;

FIG. 24 schematically illustrates a cross-sectional view along line D-D through an aspiration aperture 364 fitted with water scoop 333 of the negative floating boom 352 of the negative hydraulic loop 330;

FIG. 25 schematically illustrates a top view of an alternate embodiment of a tanker ship oil spill containment system 400 showing exemplary surface water flow patterns in a boat slip berthed with a large oil tanker ship;

FIG. 26 schematically illustrates a top view of a positive pressure hydraulic distributor 410 and negative pressure hydraulic loop 450 of the tanker ship oil spill containment system 400 showing exemplary surface water flow patterns in the boat slip without the large oil tanker ship being present;

FIG. 27 schematically illustrates a side view of a floating jet head 424 or 426 hydraulically connected with the positive pressure hydraulic distributor 410 of FIGS. 25 and 25 via the delivery pipe 414;

FIG. 28 schematically illustrates a top view of the floating jet 426 hydraulically connected with the positive pressure hydraulic distributor 410 via the delivery pipe 414;

FIG. 29 schematically illustrates a side view of a single nozzle 430 adapted to the floating jet 424;

FIG. 30 schematically illustrates a top view of double nozzle floating jet head 426 equipped with two single nozzles 430;

FIG. 31 schematically illustrates a side view of a floating vacuum scoop 464 hydraulically connected with the negative pressure hydraulic loop 450;

FIG. 32 schematically illustrates a side cross-sectional view of the floating vacuum scoop 464;

FIG. 33 schematically illustrates a top view of a portion of the floating vacuum scoop 464;

FIG. 34 schematically illustrates a top view of an alternate embodiment of an oil rig platform spill containment system 500; and

FIG. 35 schematically illustrates a top view of an alternate embodiment of a multiple ship deployed spill containment system 600.

### DETAILED DESCRIPTION OF THE PARTICULAR EMBODIMENTS

Embodiments described herein include systems and methods for removing oil, gasoline, diesel and other hydrocarbon polluted water from a body of water, separating the pollutants from the polluted water to form a cleansed water volume, and returning the cleansed water volume to the body of water or to place in storage for other uses.

The embodiments provide for a polarized distribution of positive flow sources that are deployed to at least partially circumscribe one side of an oily patch, oil slick, or other hydrocarbon patch or pollutant slick floating in a water region and negative flow sources deployed to at least partially circumscribe the other side of the oily or other hydrocarbon patch. Water emanates near or at the water line level from the positive flow sources and water is aspirated near or at the water line level by the negative flow sources. The near or at water line level water emanation and aspiration collaboratively causes the oily or other hydrocarbon patch to move from the positive flow source side towards the negative flow source side. Aspirated water surfaces containing the oily or other hydrocarbon patch are processed to separate oil or hydrocarbons from the aspirated water and return cleansed water to the water region containing the floating pollutants. The positive and negative flow sources may be deployed near a boat slip, a marina, an oil rig platform, or in open water between boats, and may be supported by floatation devices.

Other embodiments provide for the cleansed water volumes if not returned immediately to the water region, to be stored in separate containers or storage reservoirs for later delivery by the water flow sources. The cleansed water may be further rejuvenated by aeration processes prior to returning to the water region.

Other particular embodiments described also include positive water flow sources and negative water sources positioned on different sides of an oily pollutant water surface region or regions such that the positive water flow sources are aimed towards the negative flow sources. From the positive water sources a flow of water emanates substantially horizontally near or at the water line to push the oily pollutant water surface region towards the negative flow sources. The negative water flow sources are similarly positionable to receive the water pollutant laden surfaces substantially near or at the water line level pushed by the horizontally and water line level deployed positive flow sources, thereby complimentarily causing a net flow movement or urging of the oily pollutant water surface region from the positive flow source to the negative flow source.

The particular embodiments include systems and/or methods to de-pollute and clean water to its restored state within a water pool or a water region associated with freshwater or saltwater marinas. Embodiments include a positive water flow device or water delivery device that works in unison with a negative water flow device or water removal device, wherein the positive and negative flow devices are separated from each other in the water pool or water regions. The positive flow device, for example, a water jet, directs a stream of water beneath the water surface of the water pool or water regions, and causes the water surface to move towards the negative flow device by a hydraulic pushing action. The negative flow device includes a water pump and receiving port or water scoop, and with its suction action, augments the hydraulic pushing action by providing a complementary pulling action through application of a vacuum or negative pressure to the water scoop that is substantially located at water level. Water laden, oily surface contaminants collected by the scoop deployed at or near the water level line via aspiration action or suction generated from the negative pressure side of a fluid pump. The aspirated oil water layer, as an oil water mixture, may be subsequently separated to an oil portion and a cleansed water portion. The oil portion is set aside or placed in an oil container or reservoir for recycling, and the cleansed water may be aerated before for delivery back into the water pool or water regions.

The water jets of the positive flow sources and the water scoops of the negative flow sources may be deployed dockside from boat slips, marinas, oil platforms, and ships in open water used in tandem to lasso or otherwise corral at least a portion of the oil slick or patch. The water jets and water scoops may be mounted within apertures located on pipes plumbed or attached to a particular boat slip or marina, or to the apertures of flexible pipes supported by floatation devices.

Yet other embodiments described below include systems for removing a pollutant slick from a region of water that utilizes an hydraulic pump having a negative pressure side and a positive pressure side in which at least one positive flow source is positionable on a first side of the pollutant slick near the water surface adjacent to the first side, the first side of the pollutant slick intended to receive a flowing water stream or steams delivered via an aperture or orifice of a water jet that is in hydraulic communication or otherwise connected to the positive pressure side of the hydraulic pump. With the positioning of the at least one positive flow source on one side or the first side of the oil slick, at least one negative flow source positionable on a different side or a second side of the pollutant slick such that the second side will receive a suction force conveyed by the negative pressure side of the hydraulic pump to which the at least one negative flow source is connected. The water restoration system also includes an oil water separator that is connected between the positive pressure side and the at least one positive flow source. Upon engagement of the hydraulic pump, water flows from or emanates from the at least one positive flow source towards the first side of the pollutant slick and aspiration from the second side of the pollutant slick urges the pollutant slick towards the negative flow source and processing by the oil water separator to remove oil from the pollutant slick and deliver a cleansed water to the at least one positive flow source.

Other embodiments provide that the water restoration system includes a plurality of water jets that are deployable from a dock, an oil rig platform, and at least one ship positioned to at least partially circumscribe or corral the pollutant slick. The water jets may be configured to be on floatation devices. Similarly, the at least one negative flow source may include a plurality of floatable water scoops deployable orthogonally to diagonally to the first plurality of water jets.

Yet other embodiments described below include methods for removing a pollutant slick from a region of water beginning by positioning at least one positive flow source on a first side of the pollutant slick near the water surface adjacent to the first side, and positioning at least one negative flow source on a second side of the pollutant slick near the water surface adjacent to the second side. When the hydraulic pump is engaged, the methods further include emanating a first water flow from the at least one positive flow source towards the first side, and aspirating a second water flow adjacent to the second side into the at least one negative flow source. The aspirated second water contains the oil slick to which the water restoration method then continues by separating the oil from the second water flow to form cleansed water. Water restoration is completed upon merging the cleansed water with the first water flow that enters the region of water that held the now removed oil slick.

More particularly, the methods of water restoration further include that emanating the first water flow includes directing the first water flow towards the first side of the oil slick via a water jet hydraulically coupled to the positive pressure side of a water pump and aspirating the second water flow includes applying hydraulic suction to a water scoop placed near the second side of the oil slick via water scoop hydraulically coupled to the negative pressure side of the water pump. Positioning further includes placing the at least one positive flow source orthogonally to diagonally to the at least one negative flow source. The at least one positive flow source may include single headed or dual headed water jets, and the water jets may be configured to float at the water surface level using floatation devices and arranged in an array having a serial distribution.

More particular embodiments of water restoration methods include arranging the at least one positive flow source and the at least one negative flow source to be acutely and orthogonally to diagonally placed to each other with the oil slick between the positive and negative flow sources. Thus the angular arrangement could be less than 180 degrees apart from each other, or diagonally across from each other substantially at 180 degrees apart from each other. That is the oil slick or slicks may occupy the angular space between positive and negative flow sources from angles less than 90 degrees to 180 degrees. Alternate positioning between positive and negative flow sources may vary between acute angles to obtuse angles.

The methods may also include connecting the positive flow source to a first plumbing network that is connected to the positive pressure side of a hydraulic pump, and the negative flow source to a second plumbing network connected to the low pressure side of the hydraulic pump. The first plumbing network may include floatable portions that respectively provide water jets to spray water volumes at or near the water line or water surface layer containing the oil slick or slicks. Similarly, the second plumbing network may include floatable portions that respectively provide water scoops to draw in or suck in volumes of water at or near the water line or water surface layer containing the oil slick or slicks.

Together the water jets of the first plumbing network cooperatively “pushes” the oil slicks towards the water scoops while suction forces applied from the water scoops “pulls” the oil slick or slicks towards the water scoop. That is the pulling forces applied to the second side of an oil slick or slicks cooperatively adds to the pushing force of the substantially deployed water jet sprays to the first side of the oil slick or slicks to provide a cumulative motion to assists the movement of the oil slick or slicks to the water scoop. That is a vector addition of forces arising from the pushing spray and the suction forces combine to cooperatively direct the oil slick to move towards the aspirating water scoops connected with the negative pressure source.

The water jets may be single or dual headed to respectively provide single and dual water streams substantially at the water surface level of a nearby oil slick. The single and dual headed water jets may be connected in separate plumbing connections to the hydraulic pump or, alternatively, via a manifold pipe from which separate, flexible pipes may be connected to with each pipe terminated with a single or dual headed water jet. Similarly, the water scoops may be connected to their respective flexible pipes that in turn are connected to a common manifold pipe that is connected to the negative pressure side of the hydraulic pump.

The method also provides for the first plumbing network of the positive flow source to have a floatable portion, that is, the first plumbing network may be configured as a floatable positive flow source in which at least one positive flow source is deployable at or near the water line of the oil slick. The floatable positive flow source may be arranged in an array, the array including a distribution of water jets arranged in series. Similarly, the method provides for the second plumbing network to be configured in a floatable arrangement of at least one negative flow source to have a floatable configuration, that is, a floatable negative flow source in which at least one negative flow source is deployable at or near the water line of the oil slick. The floatable negative flow source may be arranged in an array, the array including a distribution of water scoops arranged in series.

The series distribution of floatable water jets and the series distribution of floatable water scoops or apertures may be deployed around an oil slick or slicks in a polarized distribution where one side of the oil slick is at least partially circumscribed by the series distribution of floatable water jets and similarly the other side of the oil slick at least partially circumscribed by the series distribution of floatable water scoops or apertures.

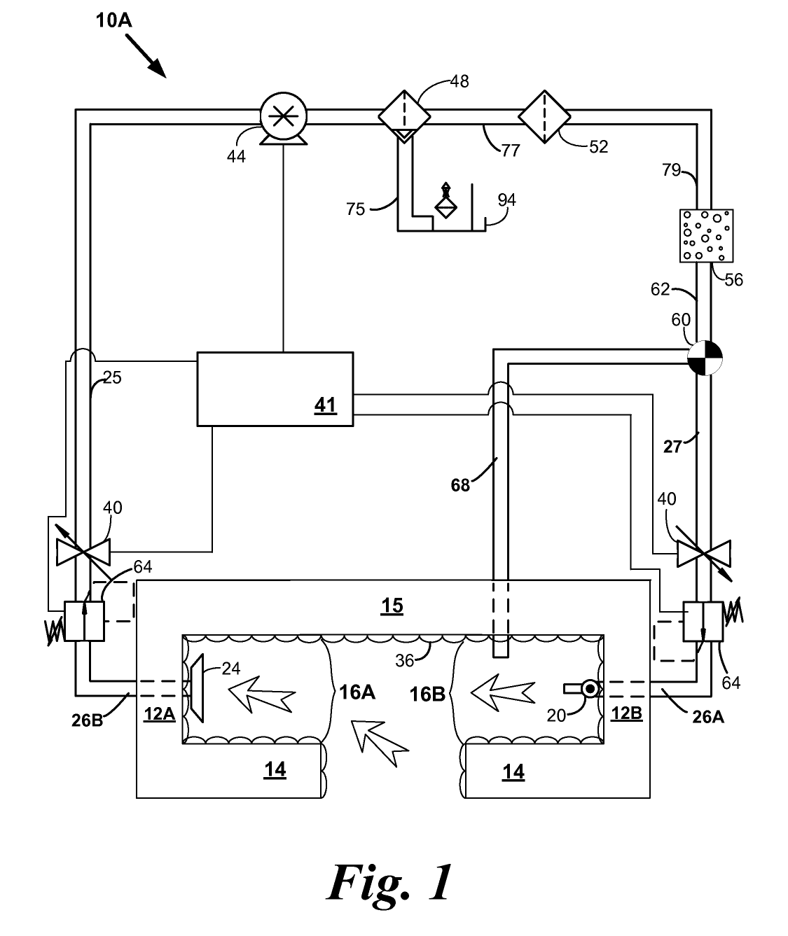

FIGS. 1-35 schematically illustrate the particular embodiments relevant to restored polluted waters contained within small boat slips and marinas designed to hold pleasure craft and small commercial ships, large boat slips designed to berth very large oil tanker ships or ocean cruise liners, and more open water environments found encircling oil drilling platforms located at sea. Also discussed are embodiments relevant to deep, open water circumstances in which partial to complete corralling of single or multiple oil slicks and their subsequent harvesting from the open water to undergo in situ oil-water separation decontamination processes.

Depicted in many of the figures within FIGS. 1-35 are flow direction arrows indicating the directional flow of water movement. Unless otherwise stipulated, white-filled arrows generally designate either the flow of surface water or the flow of water within a pipe. Black-filled arrows designate either out-flowing water streams derived from fluid expulsion or inflowing water streams derived from fluid aspiration. The out-flowing water streams or sprays originate or are expelled from nearby apertures, nozzles, or water jets and exhibit a pushing force that emanate substantially at the water surface level. The inflowing water streams similarly originate from aspiration from nearby apertures, nozzles, or water jets and exhibit a pulling force that emanate substantially at the water surface level. Diagonal line-filled arrows designate the movement direction of pollutant slicks or pollutant spills floating on or nearby a water surface arising from the pulling forces applied to one side of the pollutant slick and the pushing forces applied to the other side of the pollutant slick.

FIG. 1 schematically and pictorially illustrates a water restoration system 10A connected with an inverted U-shaped, two-pier marina showing the movement of marina water from a positive flow source to a negative flow source between adjacently opposed boat slips. The inverted U-shaped marina may be substantially rectangular and configured to have a low pressure hydraulic region and a high pressure hydraulic region in which there is a coordinated movement of marina surface water from a positive flow source to a negative flow source generally in the direction of the illustrated flow arrows between two opposing boat slips. Components of the water restoration system 10A may be located on the docks of the marina and/or may extend onto shoreline properties. The system 10A includes a low pressure pier 12A, a high pressure pier 12B, from which two opposing boat docks 14 extend to define a low pressure slip 16A located between the boat docks 14 on the low pressure pier 12A and a high pressure slip 16B located between the boat docks 14 on the high pressure pier 12B. The low and high pressure piers 12A and 12B may be slidably mounted to pilings (not shown) so that the boat docks 14 and piers 12A and 12B may float with the tide, wave action, or other causes imparted to varying marina water levels. Located between the low and high pressure piers 12A and 12B is a walking platform 15. The piers 12A and 12B may be flexibly attached to the walking platform 15 to accommodate changes in vertical distance from water level fluctuation experienced by the piers 12A and 12B.

Within the low pressure slip 16A is mounted a suction port or vacuum scoop 24. Within high pressure slips 16B is mounted a water jet 20. The water jet 20 may have a nozzle configuration to advantageously allow adjustments to the water pressure and spray patterns. The spray patterns may include columnar; fan, and laminar flow patterns. A low-pressure pipe 25 in fluid communication with the suction port 24 and removes surface water by aspirating by the suction ports 24 located on the low-pressure pier 12A. The pushing effect of water shot from water jets 20 located on the positive pressure pier 12B, preferably beneath the surface of the marina water to avoid frothing or bumping, in concert with the suction force applied from the suction ports 24, urges the marina water surface towards the suction ports 24. A high-pressure pipe 27 supplies the water delivered to the water jets 20. The low pressure pipe 25 and high-pressure pipe 27 may be made of polyvinyl chloride (PVC), other durable plastics, metal, and/or have durable and flexible sections in those regions of the system 10A where the pipes transitions from the shore side to the marina side of the system 10A to accommodate for any changes in height of the respective piers 12A and 12B due to marina water fluctuations.

Surrounding the low pressure slip 16A and high pressure slip 16B are skirts or curtains 36 that are fitted around both intake vacuum port 24, jet port 20, the space defining perimeter of the low and high pressure slips 16A and 16B, the water side of the walking platform 15, and along the ends of the docks 14. The skirt or curtain 36 serves to isolate pollutants or otherwise contain water surface bearing pollutants within the marina and prevent the leaking from the slips 16A and 16B. The skirts 36 may extend beneath the water surface or water line to contain surface riding or near surface residing pollutants. The skirt 36 provides a curtain throughout the marina to help isolate and prevent the escape under the piers 12A and 12B of at-surface and near-surface residing pollutants to optimize the delivery of directionalized surface flows to the suction port 24 for more efficient harvesting of marina polluted waters.

Referring still to FIG. 1, in hydraulic communication with the low-pressure pipe 25 and high-pressure pipe 27 are electronic control valves 40 depicted in functional schematic symbols. The electronic control valves 40 are in electrical communication with a main control panel 41. The electronic control valve 40 operates in an open-close manner and serves substantially as a diverter valve. The control valve may be plumbed between flexible piping 26 and low and high pressure pipes 25 and 27. To help adjust flow rates and measure the volume flow delivered from suction ports 24 or delivered to jets 20 are electronic pressure regulator valves 64, depicted in a functional symbol, also in electrical communication with the main control panel 41. In hydraulic communication with the low-pressure pipe 25 is a high flow fluid pump 44 which may be diesel or gasoline powered, and provides the suction force to the suction ports 24 to collect marina water and any oil pollutants. The pump 44 includes an influent channel and an effluent channel, the influent channel being in hydraulic communication with the water scoop 24 and the effluent channel in hydraulic communication with the water jet 20. The pump 44 may be in electrical communication with the electrical control panel 41, or alternatively, may be operated autonomously from the control and regulator valves 40 and 64. In alternate embodiments, the high flow pump 44 may include the Flowserve® model series DVSH between bearings axially split pumps available from Flowserve, Ashland, Tex., USA or the Gould model series AF/MPAF axial flow pumps available from Gould, Ashland, Pa., USA.

Thereafter, the pollutant laden marina water may be routed to a large capacity petroleum water separator and filter 48 depicted in a functional symbol. The separator-filter 48 extracts gas, oil, and other organics from the marina water and routes it to pipe 75 for delivery to a tank 94 or other suitable receptacle for salvaging, refinement and recycling, or to be discarded as hazardous waste. The tank 94 may be vented. Recycled petroleum products may be used in the powering of the high flow pump 44. In alternate embodiments the separator-filter 48 may include the cylindrical or rectangular configured Highland Tank Models UL-2215, Series J, Series G, and/or Series EZ Access available from Highland Tank, Stoystown, Pa., USA. The separator-filter 48 then routes the cleansed marina water via pipe 79 to a chemical micro-filter 52 to remove other wastes or particulate matter. The micro-filter 52 may include clay and/or charcoal as the filtering medium. Thereafter, via pipe 79, the cleansed and filter marina water may be oxygenated in an aerator 56. The aerator 56 has sufficient flow capacity to match the incoming marina flow volumes and may be electrically powered. Thereafter, the aerated marina water may be routed through a flow diversion valve 60, which is either set for delivery to an underwater port in the marina via bypass pipe 68, or to high-pressure jets 20 via pipe 62 that is plumbed to high-pressure pipe 27. As illustrated by example, the bypass pipe 68 delivers restored marina water to the marina by routing underneath the walking platform 15 and curtain 36.

In alternate embodiments, a water turbine electric generator (not shown) may be plumbed between the pipe 62 and pier side high-pressure pipe 27 to generate electricity from the high water flow rates from pipe 62. Electricity generated may then be routed to supplement the electric power supply to operate the high pressure pump 44.

The water movement and purification system allows for regionalized adjustments within the marina so that a generalized marina-wide de-pollution process may be undertaken, or alternatively, a de-pollution process engaged upon a sub-region or sub-zone basis. Thus, different water jets 20 and suction ports 24 may be selectively engaged to handle particularly problematic slips in cases when other slips are not sufficiently polluted.

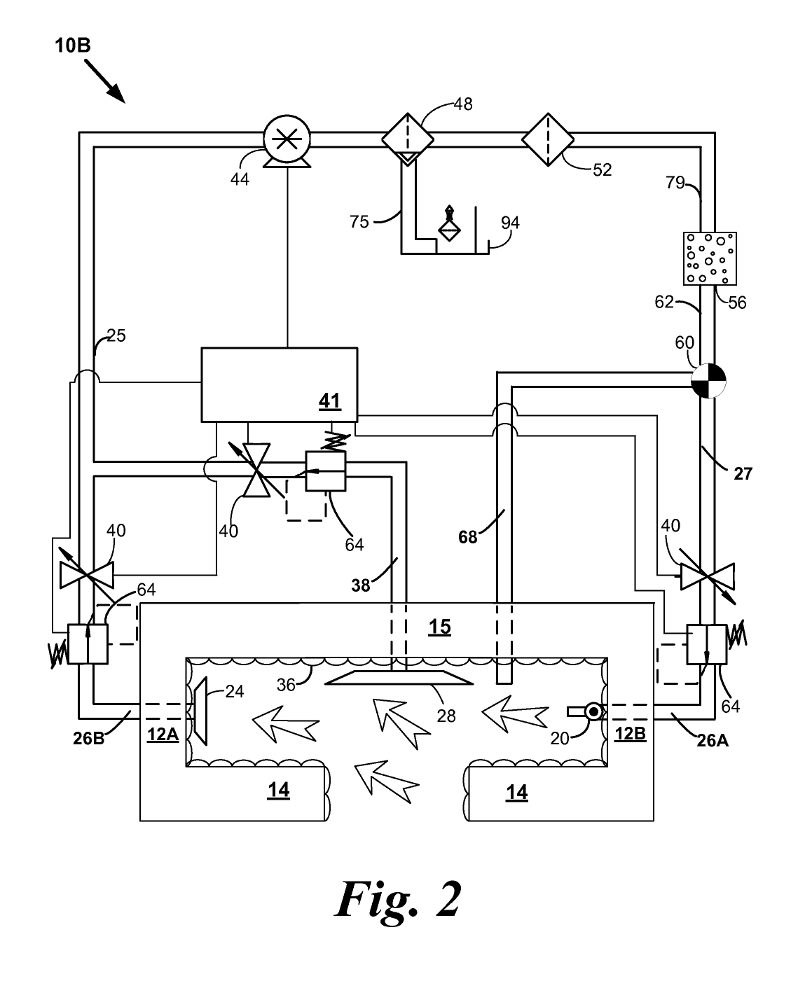

FIG. 2 schematically and pictorially illustrates an alternate embodiment of a water restoration system 10B connected with an inverted U-shaped, two-pier marina showing the movement of marina water from a positive flow source to a negative flow source between adjacently opposed boat slips. In this alternate embodiment, system 10B includes the two-pier marina being equipped with a high volume suction port 28 located near the shore end of the marina, approximately in the middle of the walking platform 15. The high volume suction port 28 further discourages the escape of marina floating oil pollutants out to open water. The shore-side located, high volume suction port 28 urges the marina water in a shore bound direction while the complimentary water jet 20 pushing and suction port 24 pulling further directs the shore bound marina surface flows to the suction ports 24 located in low-pressure slips 16A. The high volume suction port 28 may be generally perpendicular to the suction ports 24 and high velocity jet 20 and may also be opposite the marina entry port to open waters. More than one high volume suction port 28 may be installed in the marina depending on marina configuration and size. The vacuum scoops or suction ports 24 and 28 may be may be swiveled or otherwise turned to either maintain or change the intended direction of the marina water surface in concert with the water jets 20. The high volume suction port 28 is plumbed to the low-pressure pipe 25 via piping 38 as shown.

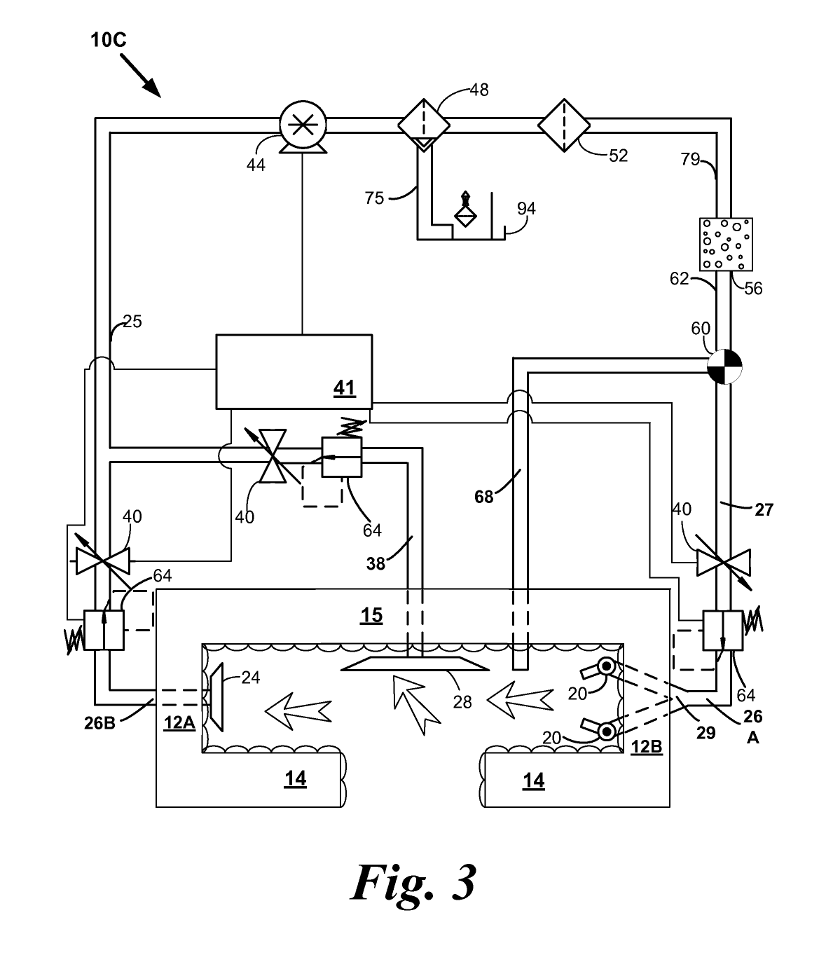

FIG. 3 schematically and pictorially illustrates an alternate embodiment of a water restoration system 10C connected with an inverted U-shaped marina showing the movement of marina water from a positive flow source to a negative flow source between adjacently opposed boat slips. Substantially similar to system 10B, system 10C adds an additional water jet 20 so that there is a pair of swivelable, and height adjustable water jets 20 within the high pressure boat slip 16B that advantageously provides for the directing or movement of water in slips occupied by boats so that water may be urged round the hull of the boats. The pair of water jets 20 is plumbed to the high pressure pipe 27 and work in concert with the water scoops 24 and 28. The high volume suction port 28 is plumbed to the low-pressure pipe 25 via piping 38 as shown. A flow splitter 29 is connected with the flexible piping 26B that in turn is hydraulically coupled with the water jets 20. The flexible tubing 26B may be comprised of wire wound spiral reinforced plastic composites of varying diameter and thickness to accommodate pressure loads and flow rates.

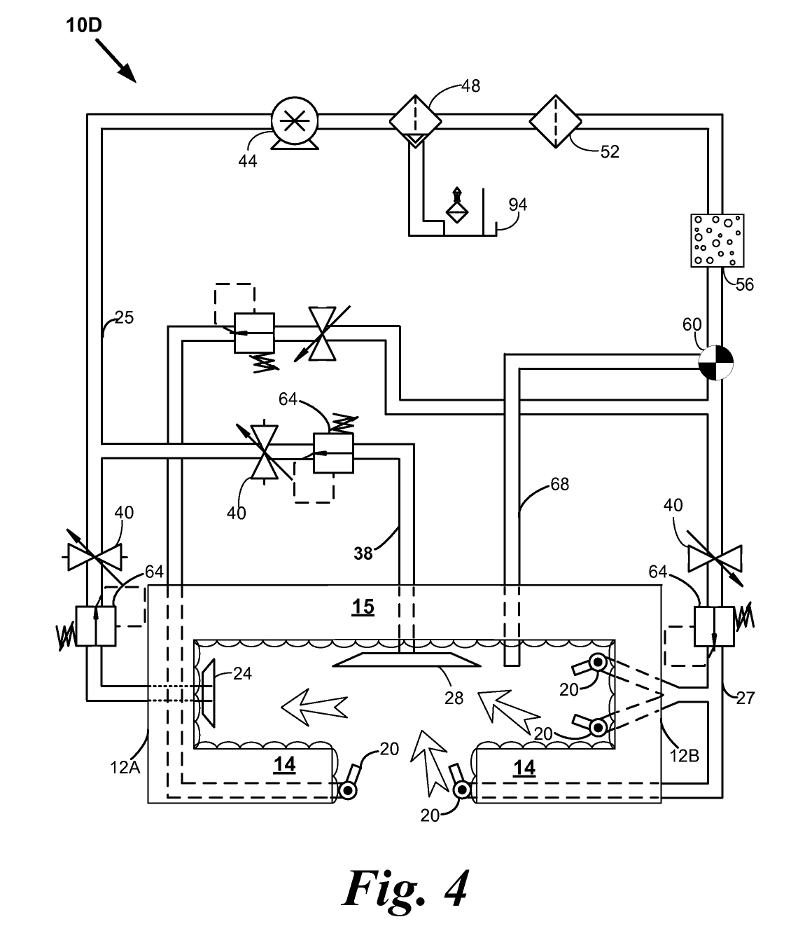

FIG. 4 schematically and pictorially illustrates an alternate embodiment of a water restoration system 10D connected with an inverted U-shaped, two-pier marina showing the movement of marina water from a positive flow source to a negative flow source between adjacently opposed boat slips. Substantially similar to system 10C, system 10D adds two additional water jets 32 located on the opposing docks 14 positioned on the marina entrance from open waters. The pair of water jets 32 is plumbed to the high pressure pipe 27 and work in concert with the water scoops 24 and 28 to further prevent the escape of polluted waters from the marina. The high volume suction port 28 is plumbed to the low-pressure pipe 25 via piping 38 as shown. The flexible tubing 26B may be comprised of wire wound spiral reinforced plastic composites of varying diameter and thickness to accommodate pressure loads and flow rates. Though not illustrated an electrical control panel 41 may be connected similarly as shown as FIGS. 1-3.

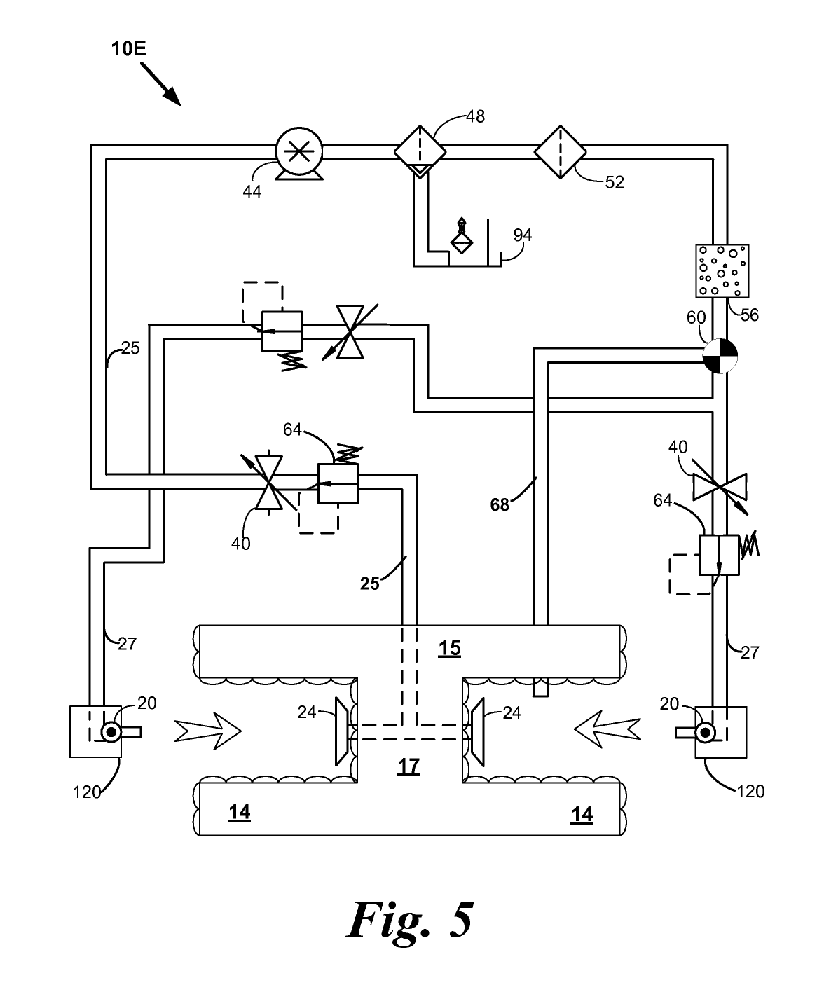

FIG. 5 schematically and pictorially illustrates an alternate embodiment of a water restoration system 10E connected with an I-shaped marina showing the movement of marina water from a positive flow source to a negative flow source between adjacently located boat slips. In system 10E, the low pressure pipe 25 may be substantially located along the midline of central pier 17. The central pier 17 floats with marina water levels along pilings (not shown) and flexibly connects with the walking platform 15. On each side of pier 17 are located two adjacent boat slips, each having a vacuum scoop 24 located on the pier side of the slip and plumbed with the low pressure pipe 25. Along the perimeter of the boat slips and termini of docks 14 and walking platform 15 are curtains 36 that serve to keep the floating contaminants confined with the boat slips. Opposing each boat slip on the open water side is a float 120 to which a water jet 20 is height adjustably mounted and plumbed with high pressure pipe 27 made of a durable and flexible material. Suction ports 24 cooperatively work with water flowing from water jets 20 to urge polluted water towards the suction port 24. The flexible tubing 26B may be comprised of wire wound spiral reinforced plastic composites of varying diameter and thickness to accommodate pressure loads and flow rates. Though not illustrated an electrical control panel 41 may be connected similarly as shown as FIGS. 1-3.

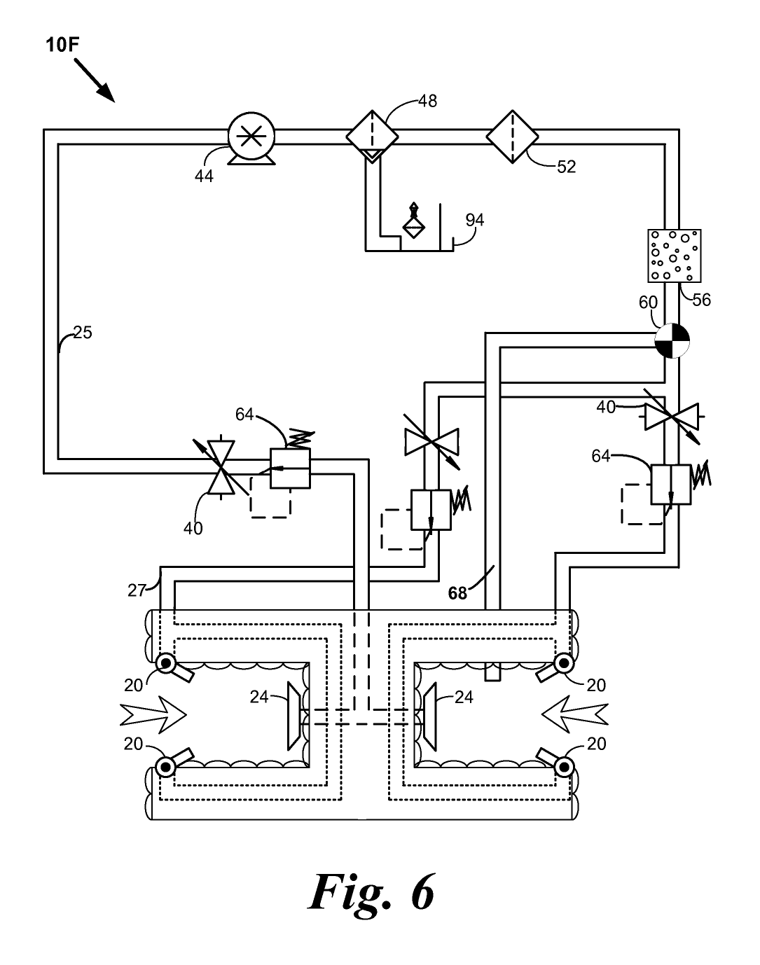

FIG. 6 schematically and pictorially illustrates an alternate embodiment of a water restoration system 10F connected with an I-shaped marina showing the movement of marina water from a positive flow source to a negative flow source between adjacently located boat slips. Substantially similar to system 10E, system 10F replaces the float 120 and installs a pair of water jets 20 mounted from the end of the right hand dock 14 and right side terminus of walkway 15. Water from the walkway 15 and dock 14 termini aim inwardly toward the vacuum port 24. This embodiment advantageously provides for the directing or movement of water in slips occupied by boats so that water may be urged round the hull of the boats and toward the vacuum port 24. Another embodiment of system 10F may include two jets 20 installed on the float 120 aimed toward the opening of the left side boat slip to similarly route water around boat hulls toward the vacuum port 24. Though not illustrated an electrical control panel 41 may be connected similarly as shown as FIGS. 1-3.

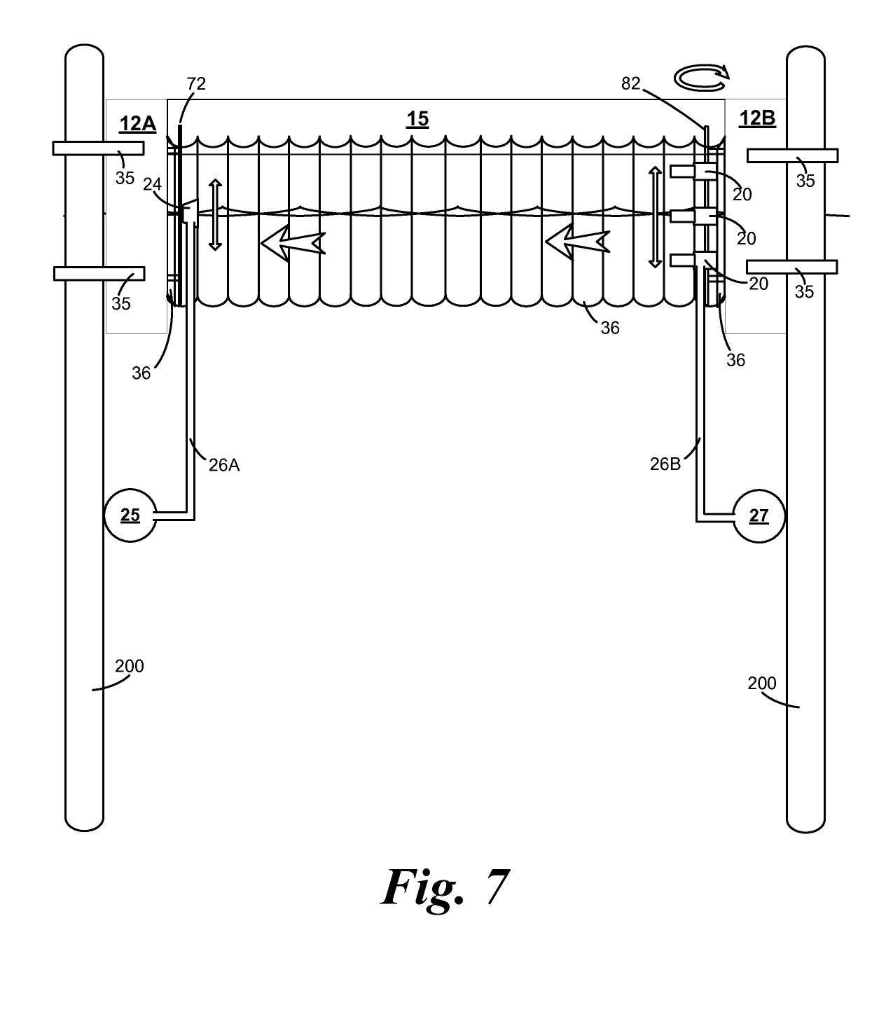

FIG. 7 is a partial cross section and side view of the opposing boat slips of the inverted U-shaped marina of FIG. 1 and detail, in general, the slidable height adjustments afforded to the vacuum port 24 and water jet 20 by respective rails 72 and 82. The rail 72 may be substantially U-shaped and is secured at each end against the side of the floating pier 12B through the curtain 36. Up and down vertical movement and rotational movement is available for positioning the water scoop 24 to optimally collect water surface and subsurface regions. Similarly, the rail 82 may be substantially U-shaped and is secured at each end against the side of the floating pier 12B through the curtain 36. Up and down vertical movement and rotational movement is available for positioning the water jet 20 to propel the movement of surface laden pollutants towards the water scoop 24. The water jet 20 is shown deployed in three vertical height locations: 1, above the water and aiming slightly downward; 2, at water level aiming horizontal; and 3, slightly beneath the water level and aiming horizontal. In addition to the vertical height adjustments, rotational adjustments are provided for in designs described below.

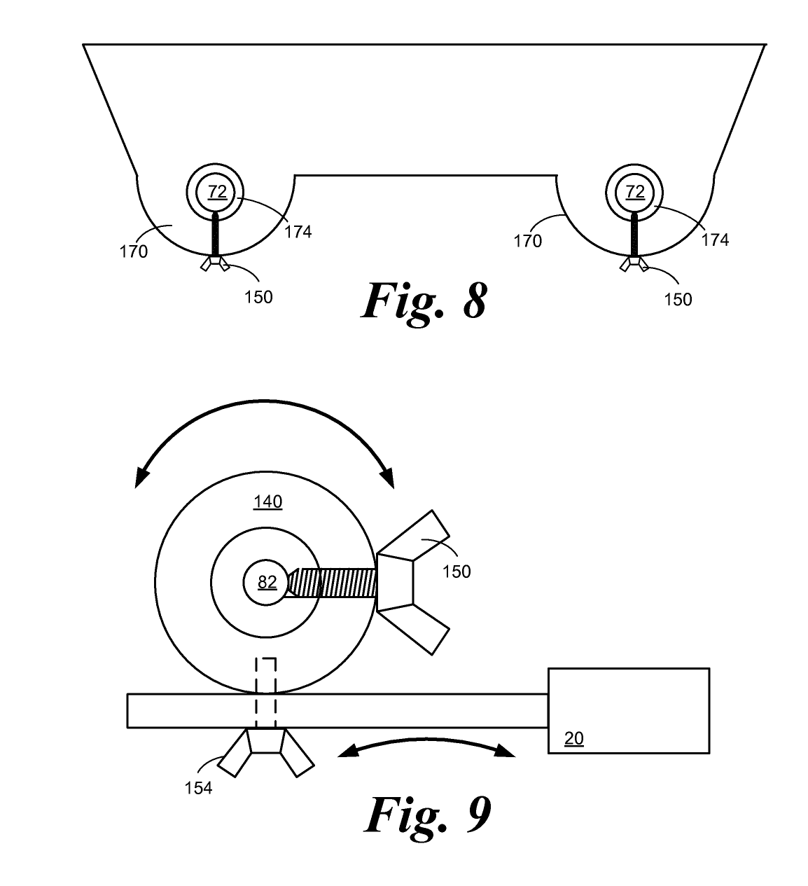

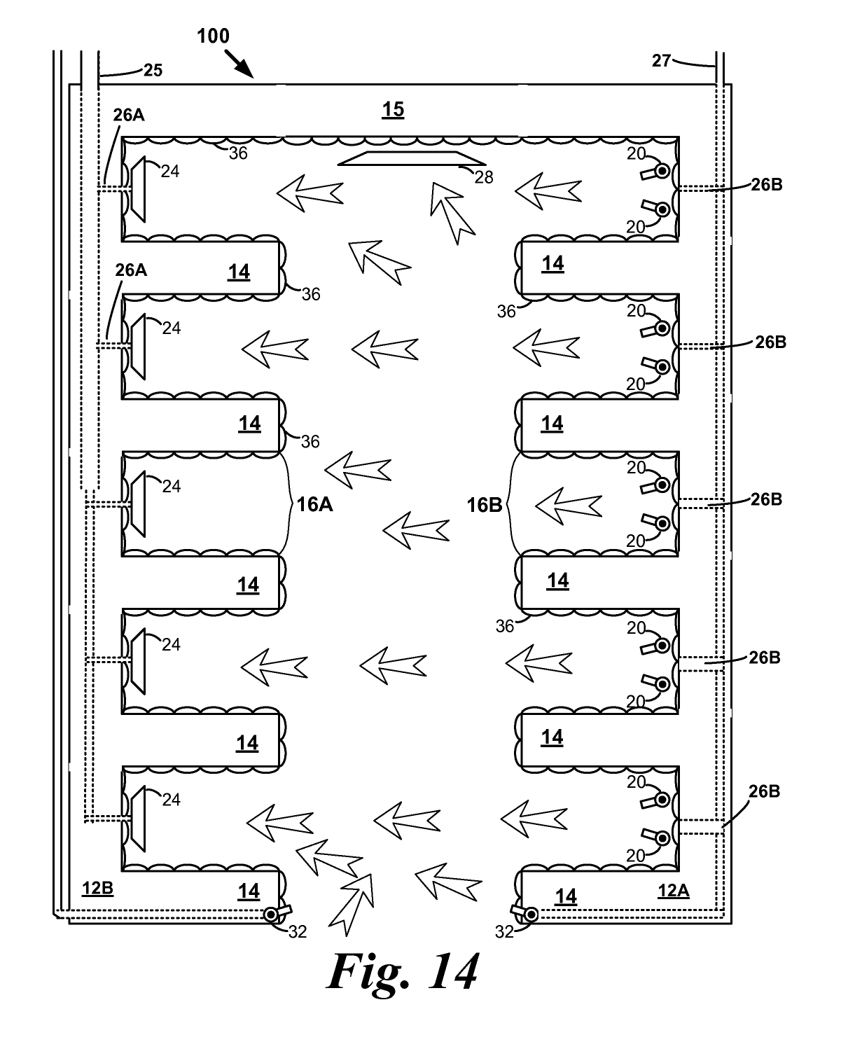

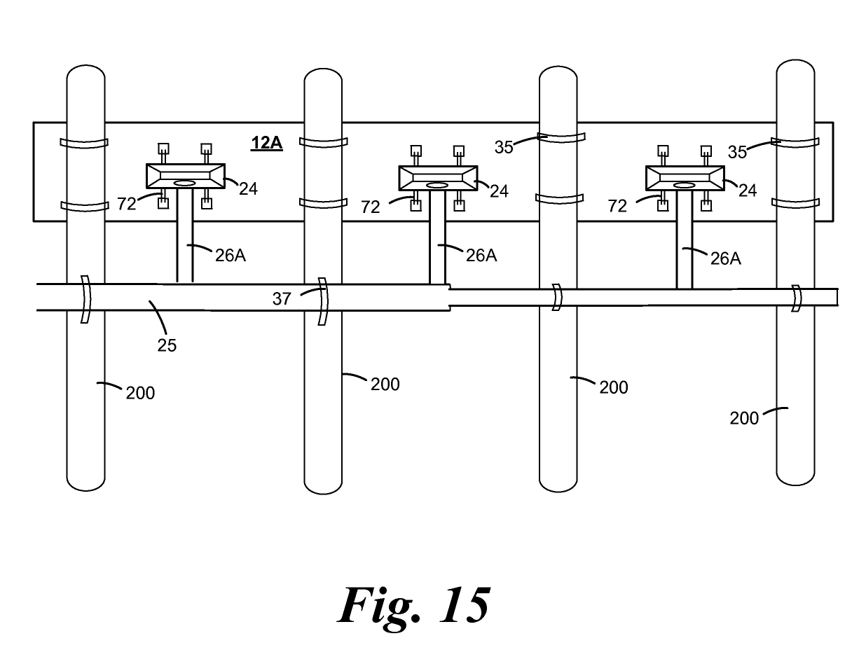

FIG. 8 is an expanded top view of the suction port or water scoop 24 slidably engaged with the rails 72 of FIG. 7. The water scoop 24 includes two flanges 170 having an orifice 174. The rail 72 may be substantially U-shaped and is secured against the side of the floating pier 12B as shown in FIG. 15 below. The rails 72 may include a straight portion that engages through an orifice 174 of flange 170 to slidably position the water scoop 24 along the rail 72 through a desired vertical height in relation to the water surface. Engagement of the two flanges 170 with the two rails 72 primarily limits the movement of the water scoop 24 to an up and down vertical direction. The water scoop holder 24 is positioned to a desired vertical height along the rails 72 in relation to the water level and then secured to the desired vertical height by clamp screws 150. Clamp screws 150 are threaded and engage with complimentary threads (not shown) in a threaded channel (not shown) that allows transiting of the shaft part of the clamp screw 150 to firmly pinch crab against the rail 72. The two-flange arrangement may also be employed in the high volume water scoop 28 located midway between boat slips along walkway 15 of FIGS. 2-4 above and FIG. 14 below.

FIG. 9 is an expanded top view of the water jet 20 slidably engaged with the rail 82 of FIG. 7 using clamps to provide rotation and tilt movement. Securing of a user-selected vertical movement of the water jet 20 along the linear portion of rail 82 is provided by the clamp screw 150 to firmly pinch crab against the rail 82. Tilt movement about the water jet holder 140 is provided by tilt clamping screw 154.

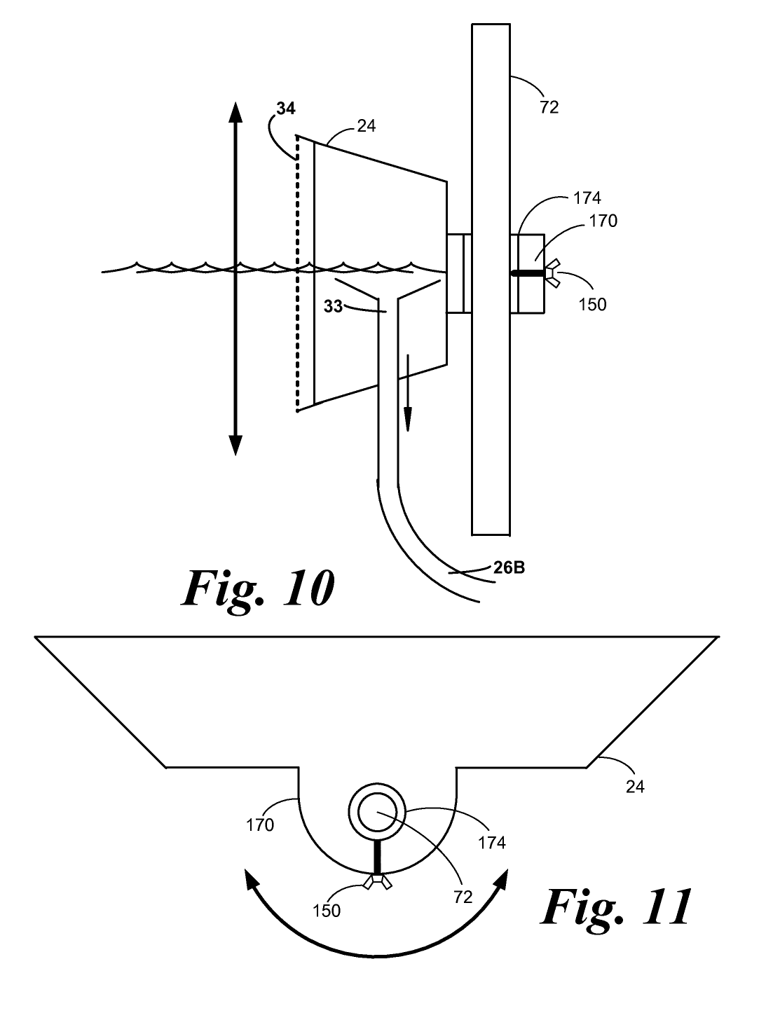

FIG. 10 is an expanded side view of an alternate embodiment of the water scoop 24 slidably engaged with the rails 72 of FIG. 7. Placed in front of the opening to the water scoop 24 is a coarse screen 34 to strain large floating debris, for example, wood fragments and disposable bottles from entering into a water funnel 33 that is in hydraulic communication with the flexible piping 26B. The scoop 24 is shown adjusted at water surface level by the clamp screw 150 that firmly pinch crabs against the rail 72 though flange 170. The water funnel 33 is shown beneath the water level to suck in water surface bearing pollutants under the negative pressure influence of pump 44.

FIG. 11 is an expanded top view of an alternate, pivotable embodiment of the suction port 24 slidably engaged with the rail 72 of FIG. 7. The boat slips depicted in FIGS. 1-6 may be equipped with a single rail 72. In additional to vertical movement, the scoop 24 in this alternate embodiment gains rotational movement through a centrally located flange 170 in a plane substantially perpendicular to the axis of the single rail 72. After adjusting the rotational position of the suction port 24, both the vertical height and rotational angle of the suction port 24 is secured through the pinching action of clamp bolt 150 against the rail 72.

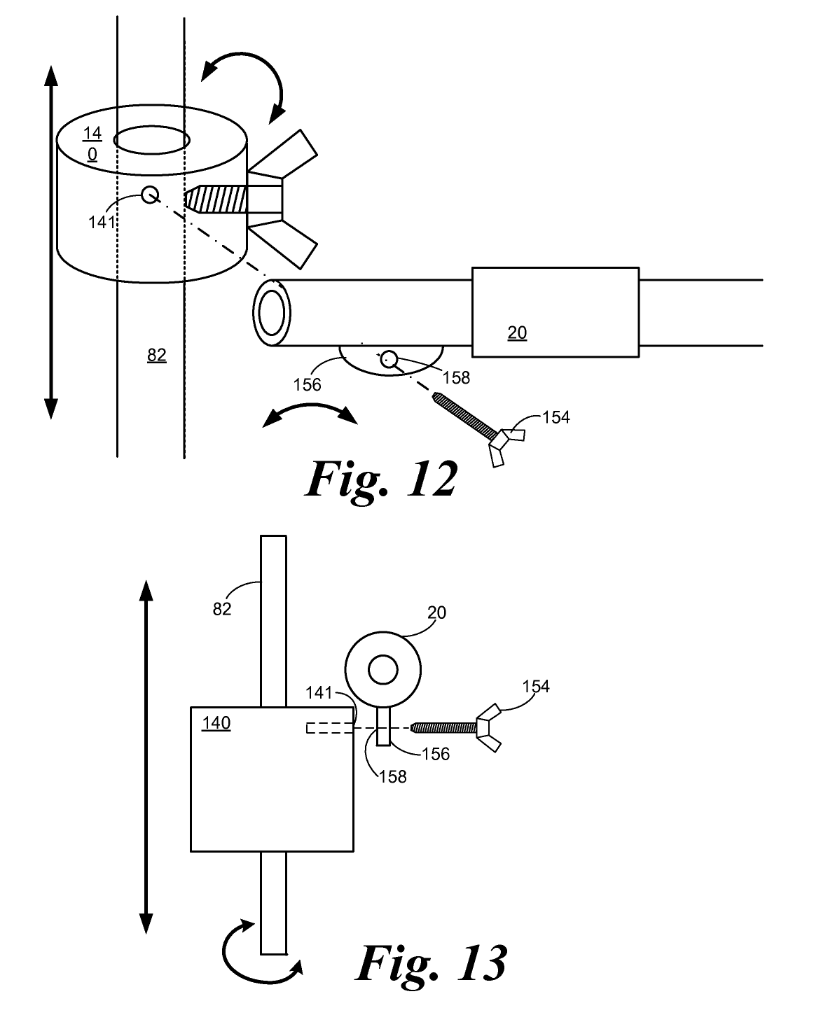

FIG. 12 is an expanded side perspective view of the water jets 20 and 32 slidably engaged with the rail 82 via jet nozzle holder 140 assembly providing a vertical, rotation, and tilt movements. The nozzle holder 140 details the tilt adjustments afforded to the water jet nozzles 20 and/or 32. Attached to the jet nozzles 20 or 32 is a flange 156 having a flange orifice 158. The flange 156 fits against the side of the nozzle holder 140 to align the flange orifice 158 with a nozzle orifice 141. The depth of the nozzle orifice 141 need not pass through to the rail 82. The tilt-securing clamp 154 is passed through flange orifice 158 and thence to the nozzle orifice 141 for threaded engagement, and subsequently tightened until the desired tilt angle to the nozzle of water jets 20 and/or 32 is secured.

FIG. 13 is an expanded side view of the water jet 20 slidably engaged with the rail 82 of FIG. 12. The tilt-securing clamp 154 is passed through flange orifice 158 and thence to the nozzle orifice 141 for threaded engagement, and subsequently tightened until the desired tilt angle to the nozzle of water jets 20 and/or 32 is secured.

FIG. 14 schematically illustrates a water restoration system 100 for a multi-slip marina that is an expansion of the inverted U-shaped two-slip marina of FIG. 4. The system 100 includes the low pressure pier 12A, the high pressure pier 12B, from which a plurality of boat docks 14 extend to define five low pressure slips 16A located between the boat docks 14 on the low pressure pier 12A and five high pressure slips 16B located between the boat docks 14 on the high pressure pier 12B. The marina-based system 100 may include multiples and submultiples of the low and high pressure boat slips 16A and 16B. Within the low pressure slips 16A is mounted the suction port or vacuum scoop 24. Within the high pressure slips 16B is mounted at least one water jet 20, here illustrated as a pair. The low-pressure pipe 25 is in fluid communication with the suction ports 24 and removes surface water aspirated by the suction ports 24 located on the low-pressure pier 12A. The low pressure pipe 25 may be made of polyvinyl chloride (PVC), other durable and flexible plastics chemically resistant to organic fluids, or metal. The pushing effect of water shot from water jets 20 located on the positive pressure pier 12B, preferably beneath the surface of the marina water to avoid frothing or bumping, in concert with the suction force applied from the suction ports 24, urges the marina water surface towards the suction ports 24. The high-pressure pipe 27 supplies the water delivered to the water jets 20. The high-pressure pipe 27 may be made of polyvinyl chloride (PVC), other durable and flexible plastics, or metal. Surrounding the low pressure slips 16A and high pressure slips 16B are skirts 36 that are fitted around both intake vacuum ports 24 and jet ports 20 to isolate or contain pollutants within the boat slips 16A or 16B so as not to escape underneath the piers 12A and 12B and thence from the marina. The skirts 36 may extend beneath the water surface or water line to contain surface riding or near surface residing pollutants. The skirt 36 provides a curtain throughout the marina to help isolate and prevent the escape under the piers 12A and 12B of at-surface and near-surface residing pollutants to optimize the delivery of directionalized surface flows to the suction port 24 for more efficient harvesting of marina polluted waters.

Greeting the open water entering the marina are constant velocity high volume water jets 32 to significantly prevent the escape of directionalized moving surface water to the open sea from the marina at the end of the terminal or open water located docks 14 extending from the low and high pressure piers 12A and 12B. Marina entrance located water jets 32 help isolate sub-areas of the marina water surface to prevent cross contamination to open water beyond the marina entrance. The water jets 32 may have higher flow rates than slip-mounted jets 20. The water jets 20 and 32 may be swiveled or otherwise rotated to either maintain or change the intended directional flows of the marina water surface towards suction ports 24 located in low-pressure slips 16A. Alternate embodiments include the marina being equipped with a high volume suction port 28 located near the shore end of the marina to further discourage the escape of marina floating oil pollutants out to open water. The shore-side located, high volume suction port 28 urges the marina water in a shore bound direction while the complimentary water jet 20 pushing and suction port 24 pulling further directs the shore bound marina surface flows to the suction ports 24 located in low-pressure slips 16A. The high volume suction port 28 may be generally perpendicular to the suction ports 24 and high velocity jets 20 and may also be opposite the marina entry port to open waters. More than one high volume suction port 28 may be installed in the marina depending on marina configuration and size. The vacuum scoops or suction ports 24 and 28 may be may be swiveled or otherwise turned to either maintain or change the intended direction of the marina water surface in concert with the water jets 20 and 32. The diameter of the flexible piping 26B may progressively increase the further the water jets 20 are from the effluent side of the pump 44. Similarly, the diameter of the low pressure pipe 25 may progressively decrease the further the water scoops 24 are from the influent side of the pump 44.

FIG. 15 schematically and pictorially illustrates in side view the plumbing configuration of the marina negative flow sources of water restoration system 100 of FIG. 14. The scoop configuration of suction ports 24 are shown attached with the low pressure pier 12A in the low-pressure slips 16A are shown plumbed to low-pressure pipe 25 via flexible piping 26A. As the pier 12A rises and falls within the tide in the marina or due to other causes such as wave action, flooding and drought about the pilings 200 within the bands 35, the flexible piping 26A accommodates the change in vertical distance experienced by the low-pressure pier 12A. The low-pressure pipe 25 may be reduced in diameter near the more extended regions of the marina to accommodate and adjust flow suction forces to the more distally located suction ports 24 from the influent side of pump 44 so that flow suction rates in slips between shore side and open water side are substantially equalized. The low-pressure pipe may be secured directly to the pilings 200 via brackets 37, or alternatively, underneath the low-pressure pier 12A with flexible connectors to maintain hydraulic communication with the influent side of pump 44 due to variations in float height experienced by the low-pressure pier 12A.

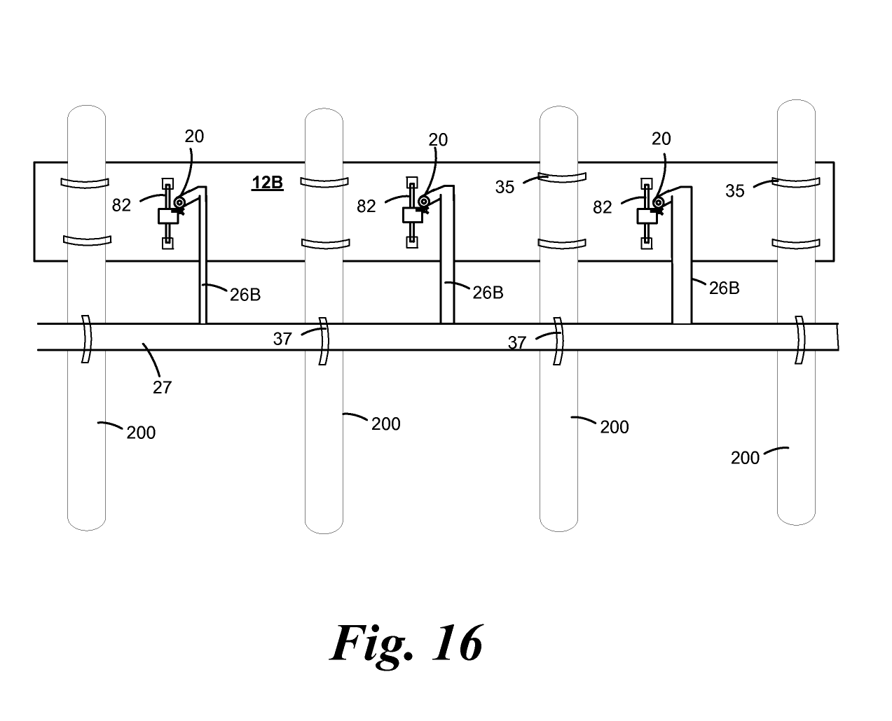

FIG. 16 schematically and pictorially illustrates in side view the plumbing configuration of the marina positive flow sources of water restoration system 100 of FIG. 14. The scoop configuration of water jets 20 are shown attached with the high pressure pier 12B in the high-pressure slips 16B are shown by plumbed high-pressure pipe 27 via flexible piping 26B. As the pier 12B rises and falls within the tide in the marina or due to other causes such as wave action, flooding and drought about the pilings 200 within the bands 35, the flexible piping 26B accommodates the change in vertical distance experienced by the high-pressure pier 12B. Attached or otherwise mounted to the high-pressure pier 12B is the rail 82 to which are slidably coupled the high flow jets 20. As illustrated, a single flow jet 20 is slidably and pivotably mountable to a single rail 82. The rail 82 is sufficiently long enough to permit above water jet spraying, at the water surface jet spraying, and, in a particular embodiment below the water surface jet spraying from the high flow jets 20 as shown in FIG. 7. A similar mounting arrangement for rail 82 is configured for the terminal or open water located docks 14 extending from the low-pressure pier 12A and high-pressure pier 12B for the marina entrance water jets 32. The marina entrance water jets 32 may be similarly adjusted for above surface, at surface and below surface water jetting. Alternate embodiments for underwater jetting by jets 20 and 32 may include depths ranging from just below the water surface to approximately eight inches. Pivotable attachments similar to that illustrated in FIG. 7 allow the jets 20 and 32 to be rotatable above, on, and beneath the water surface within the sliding distances conferred by the rails 82.

The water jets 20 within high-pressure slips 16B and water jets 32 mounted near the ends of docks 14 are plumbed to the high pressure pipe 27 via piping flow splitter 29 and flexible piping 26B when a pair of water jets 20 are deployed in the high-pressure boat slips illustrated in FIG. 14. The diameter of the flexible piping 26B may be progressively enlarged from the shore-side slips 16B to the open waterside slips 16B to equalize water flow rates from the water jets 20. Alternatively, flow constrictors having sufficiently increasing diameters may be mounted within the high-pressure pipe 27 in a shore-to-open water direction allowing the flexible piping 26B to have approximately the same diameter for each slip along the high-pressure pier 12B. The flexible piping 26B may be comprised of wire wound spiral reinforced plastic composites of varying diameter and thickness to accommodate pressure loads and flow rates. For example, as illustrated, the diameter of the flexible piping 26B progressively increases the further the water jets 20 are from the effluent side of the pump 44. The high-pressure pipe 27 may be secured directly to the pilings 200 via brackets 37, or alternatively, underneath the high-pressure pier 12B with flexible connectors to maintain hydraulic communication with the effluent side of pump 44 due to variations in float height experienced by the low-pressure pier 12B.

The water movement and purifications systems described may also be adapted to single pier marinas in which boat slips on each side of the pier are configured as low pressure boat slips 16A, mounted with suction ports 24, and enveloped with a curtain 36. The high pressure flow source 20B could be provided on a movable platform or boat to which at least one jet 20 is mounted, a skirt 36 extension stretched to each side of the dock 14, and plumbed with flexible hoses sufficient to withstand and deliver the operational pressures optionally advantageous for generating a high-pressure region to low pressure region surface flow direction. In such a single pier configured system, the floating platform may migrate on a slip-by-slip basis to sequentially remove slip-residing pollutants along the one and/or both sides of the single pier.

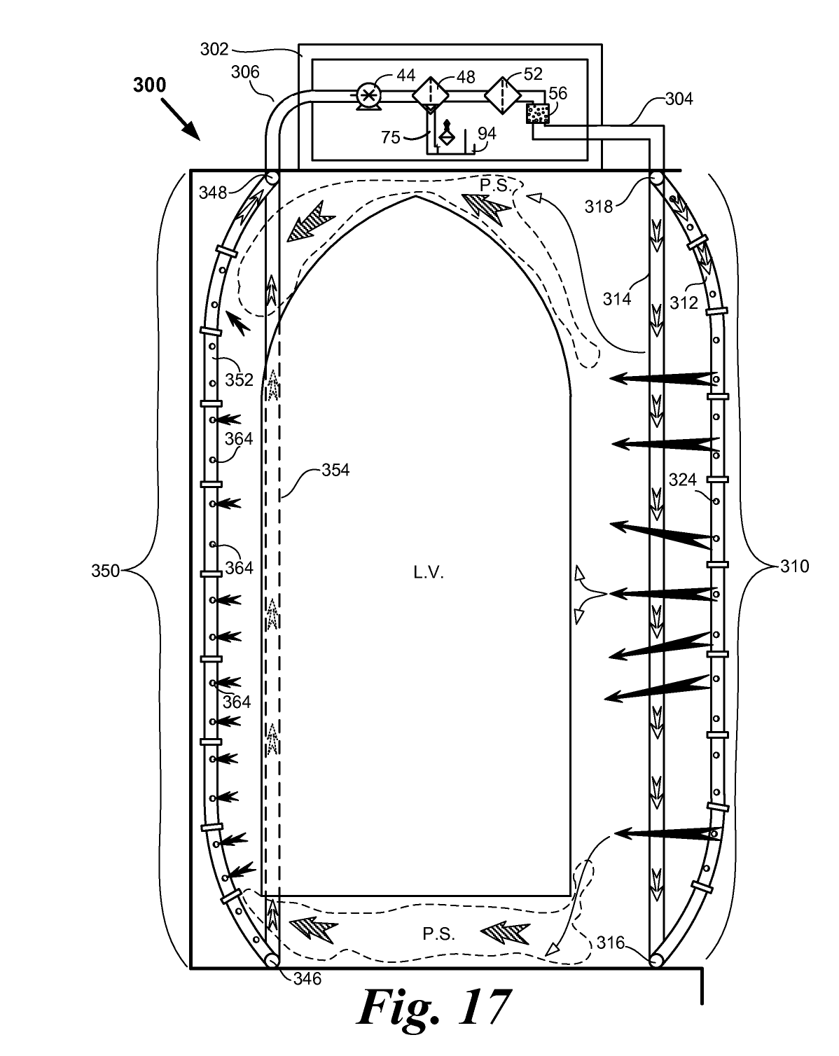

FIG. 17 schematically illustrates a top view of an alternate embodiment of a tanker ship oil spill containment system 300. Spill containment system includes a water purification system 302 having the high flow pump 44, the pollutant or separator-filter 48, the container or tank 94 configured to receive surface oils or other surface floating or associated pollutants, the chemical micro-filter 52, and the aerator 56, each connectable in series and having sufficient flow capacity to handle pollutant spills or pollutant slicks (P.S.) such as oil spills floating on or nearby the water surface, emanating from and/or accumulating within the large vessel (L.V.) berth. Attached to outflow pipe 304 is a positive pressure hydraulic loop 310 that is positioned on one side of the LV berth. Attached to inflow pipe 306 is a negative pressure hydraulic loop 350 positioned on the other side of the LV berth. A directional flow of surface water moving from the positive flow side of the L.V. berth to the negative flow side of the L.V. berth is generated from positive and negative hydraulic forces respectively conveyed to the positive and negative pressure loops 310 and 350 by high flow pump 44.

The positive pressure hydraulic loop 310 includes a floatable outflow surface pipe 312 and a submersible delivery pipe 314 connected to the floatable surface pipe 312 via connector pipes 316, 318 located at proximal and distal locations to the outflow pipe 304. The delivery pipe 314 partitions the flow from the outflow pipe 304 to the proximal and distal locations of the floatable surface pipe 312. This flow partitioning allows for an even distribution of positive pressure water throughout the length of the floatable surface pipe 312. Water flow directed inwardly and substantially at the surface level of the water towards the berth and in the direction of the large vessel L.V. is shown as indicated by stretched flow directional arrows from a plurality of out-flow apertures 324 aimed inwardly to the berth to deliver water streams at or near one side of surface layer containing floating pollutants in the L.V. berth.

Similarly, suction forces generated by the low or negative pressure side of high flow rate pump 44 are conveyed to a floatable inflow pipe 352 having a plurality of inflow apertures 364. The suction forces are conveyed to the inflow pipe 352 by a submergible collection pipe 354 connected with the negative pressure side of pump 44 via inflow pipe 306. The collection pipe 354 is attached to the floatable inflow pipe 352 by connector pipes 346, 348 located at proximal and distal locations to the inflow pipe 354. This flow partitioning allows for an even distribution of negative pressure or vacuum forces water throughout the length of the floatable inflow surface pipe 352. The suction or vacuum forces are communicated throughout the plurality of inflow apertures 364 resulting in suction streams (denoted by the black-filled flow direction arrows with arrowhead pointing towards the inflow apertures 364) being drawn into the interior of the floatable inflow pipe 352. The inwardly drawing of surface water on one side of the pollutant slick P.S. via the inflow apertures 364 with the outwardly delivered fluid streams conveyed from the outflow apertures 324 on the other side of the pollutant slick P.S provide vector additive or pushing forces (denoted by the black-filled flow direction arrows with tail end leaving from the outflow apertures 324) to cooperatively urge the movement of the pollutant slick towards and aspiration by the inflow apertures 364. Migration of the pollutant slick P.S (dashed line) around the large vessel L.V. and towards plurality of inflow apertures 364 is illustrated with diagonal cross-line arrows with arrowhead facing towards the inflow pipe 352. Water surface containing pollutant slicks P.S. are sucked inside the floatable inflow pipe 352 via the inflow apertures 364 for accumulation in the collection pipe 354 and then delivery to the lower or negative pressure side of the high capacity pump 44 via inflow pipe 306.

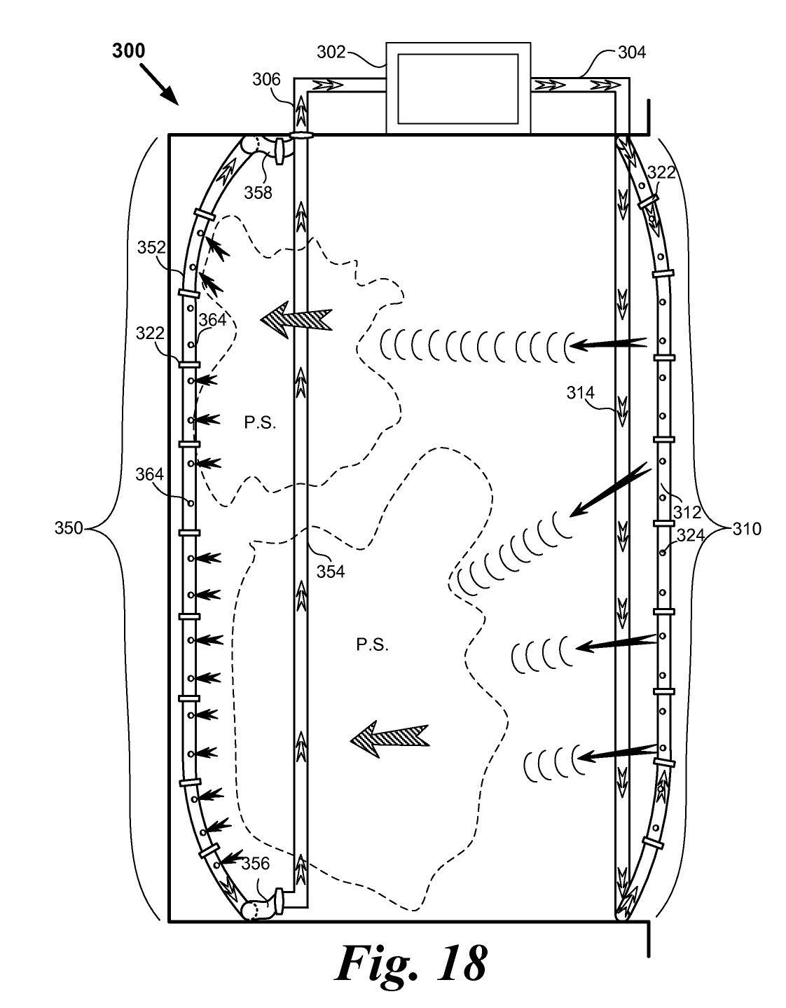

FIG. 18 schematically illustrates a top view of the positive pressure hydraulic loop 310 and negative pressure hydraulic loop 350 of the tanker ship oil spill containment system 300 showing exemplary surface water flow patterns in the boat slip without the large oil tanker ship being present. Here the cooperative migration of oil spills or pollutant slicks P.S is more readily achieved as the large vessel L.V., being absent, does not present a barrier to circumnavigate and the additive pull-and-push hydraulic streams aids in the pollutant slicks migration to the floatable inflow pipe 352 and its subsequent aspiration of the water laden, oily surface contaminants contained within the pollutant slicks P.S. are sucked into the inflow apertures 364.

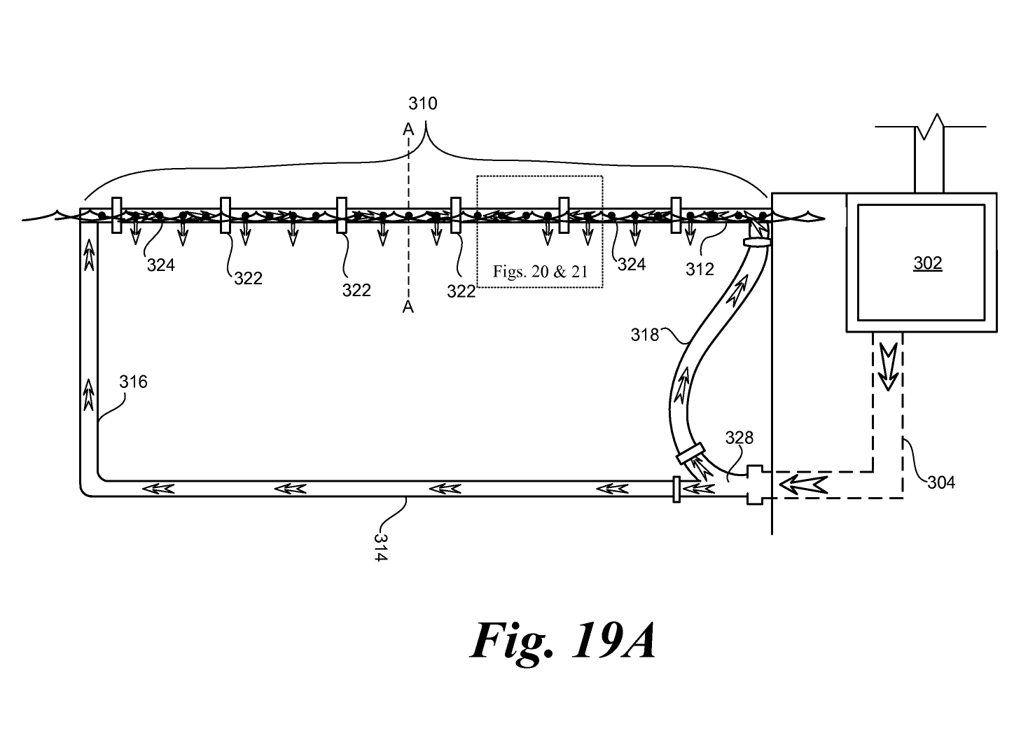

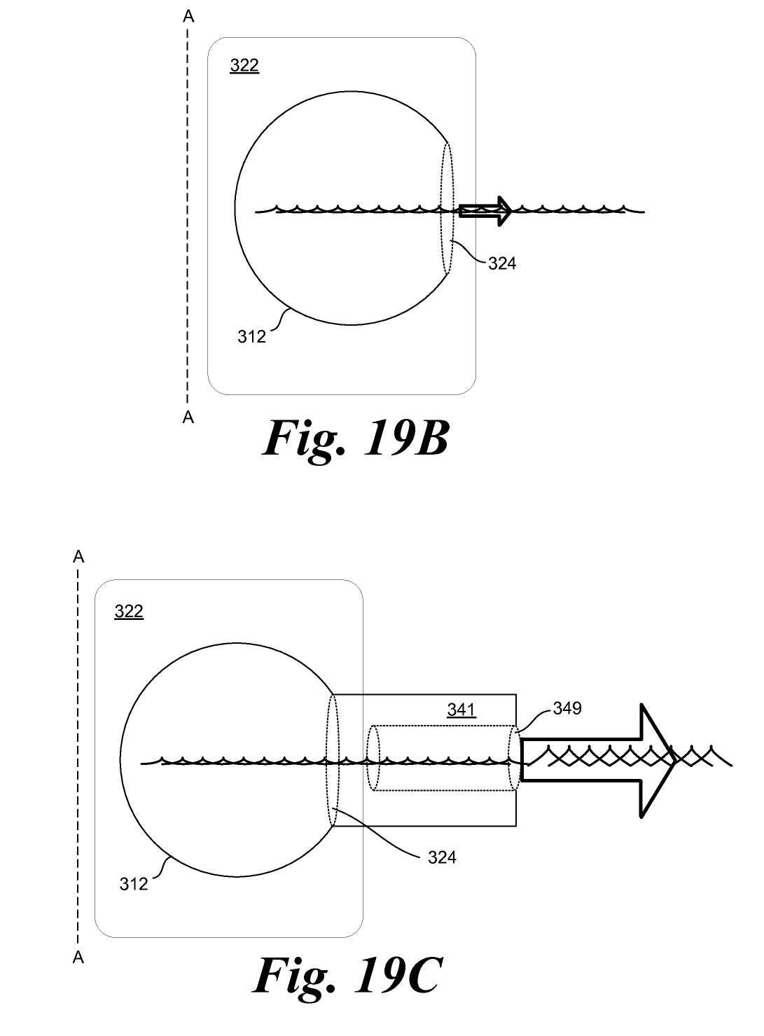

FIG. 19A schematically illustrates a side view of the positive hydraulic loop 310 of the tanker ship oil spill containment system 300 on one side of the large vessel L.V. berth. Cleansed water delivered from the water purification system 302 via outflow pipe 304 enters the proximal connector pipe 318 that is proximal or closer to the dockside located outflow pipe 304. The cleansed water enters the distal connector pipe 316 that is distal or farther away from the dockside located outflow pipe 304 via the submerged delivery pipe 314. Cleansed water then enters the proximal and distal sides of the floatable pipe 312 for out-streaming from outflow apertures 324 substantially at the surface level of the water. Multiple floats 322 are distributed at intervals throughout the length of the floatable pipe 312. The floatable pipe 312 is preferably made of a flexible material that allows a range of horizontal and vertical bending to provide for shaping the form of the floatable pipe 312 beyond substantially linear or parabolic configurations. The bendable nature of the floatable pipe 312 allows for adjusting the curvature to match the shape of that portion of the pollutant slick to which out flowing streams from the outflow apertures 324 are directed.

FIG. 19B schematically illustrates a cross-sectional and side view along line A-A of pipe 312 of the positive hydraulic loop 310. Here the parabolic apex 329 of the outflow aperture 324 is bisected by the surface water depicted as waves. The large directional flow arrow signifies the substantially horizontal direction of the out flowing cleansed water streams at or near the surface water layer holding the pollutant slick. Behind the cross-section of the outflow pipe 312 is the float 322.

FIG. 19C schematically illustrates a cross-sectional and side view along line A-A of FIG. 19A of the out flow aperture 324 fitted with an outwardly directed water jet 341 to produce an enhanced expulsion or pushing force at a smaller outflow aperture 349. The outwardly directed flow arrow depicted in FIG. 19C is larger to designate a larger or enhanced pushing or expulsion force applied through the smaller outflow aperture 349 as compared to the smaller pushing or expulsion force designated by the smaller outwardly directed flow arrow incident to the larger outflow aperture 324 depicted in FIG. 19B. The size of the smaller aperture 349 may be variably adjusted by a turning mechanism (not shown) or by insertable washers (not shown) to vary the expulsion or pushing force that emanate from the water jet 341. The outwardly directed water jet 341 may be configured with turbines (not shown) that are powered with electric motors (not shown) to increase the outwardly directed flow rates and pushing forces applied to the sides of a nearby pollutant slick.

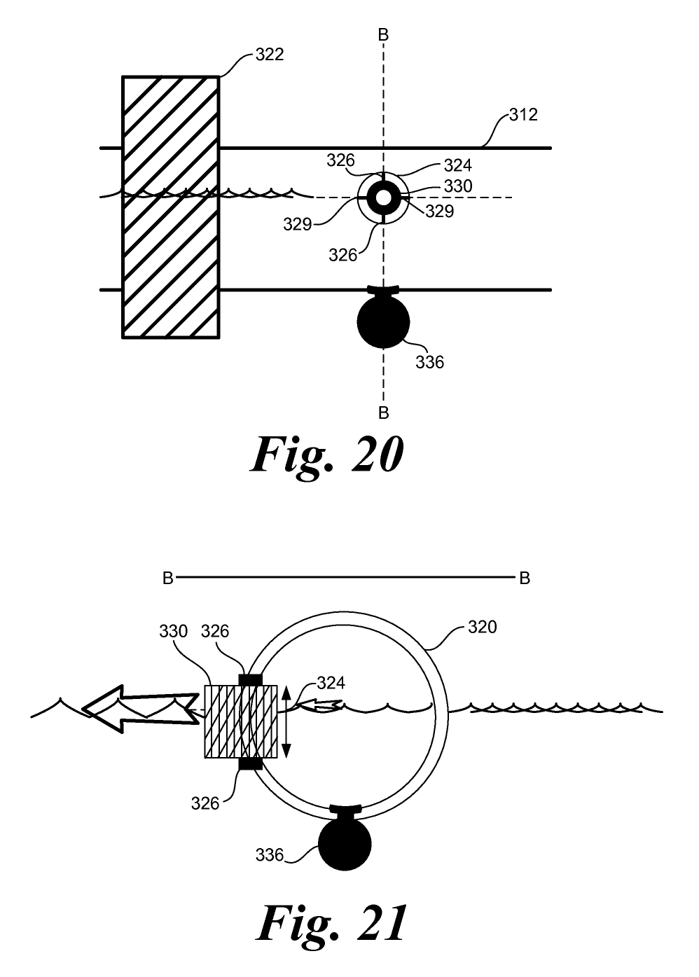

FIG. 20 schematically illustrates a side view of the positive floating boom or positing flow outflow pipe 312 of the positive hydraulic loop 310 in which the outflow aperture 324 is fitted with an hydraulic jet 330. The hydraulic jet 330 is configured to be pivotable about vertical axis 326 and horizontal axis 329 to provide adjustment in the directional flow to more forcefully amplify the expulsive forces within the flowing streams directed along or near the waterline against at least a portion of one side of the pollutant or oil slick floating in the large vessel L.V. slip. A weight 336 suspended from the bottom of the floating pipe 312 beneath the waterline helps stabilize the float 322 in holding the floatable outflow pipe 312. More than one weight 336 may be distributed along intervals of the length of the floating pipe 312 to stabilize its placement.

FIG. 21 schematically illustrates a cross-sectional view along line B-B through the hydraulic jet 330 of positive floating boom 320 of the positive hydraulic loop 310. The hydraulic jet 330 is configured to provide an increased hydraulic thrust or force to the outflow streams of the aperture 324 designated by the vertical double arrow. The hydraulic jet 330 may include nozzles configured to have variable constrictions (not shown) or insertable constrictors (not shown) to variably or incrementally increase the thrusting or amplification of the outflow streams emanating from the aperture 324. The weight 336 counterbalances or otherwise dampens the rocking forces arising from action-reaction vectors as the boosted hydraulic forces emanate from the hydraulic jet 330.

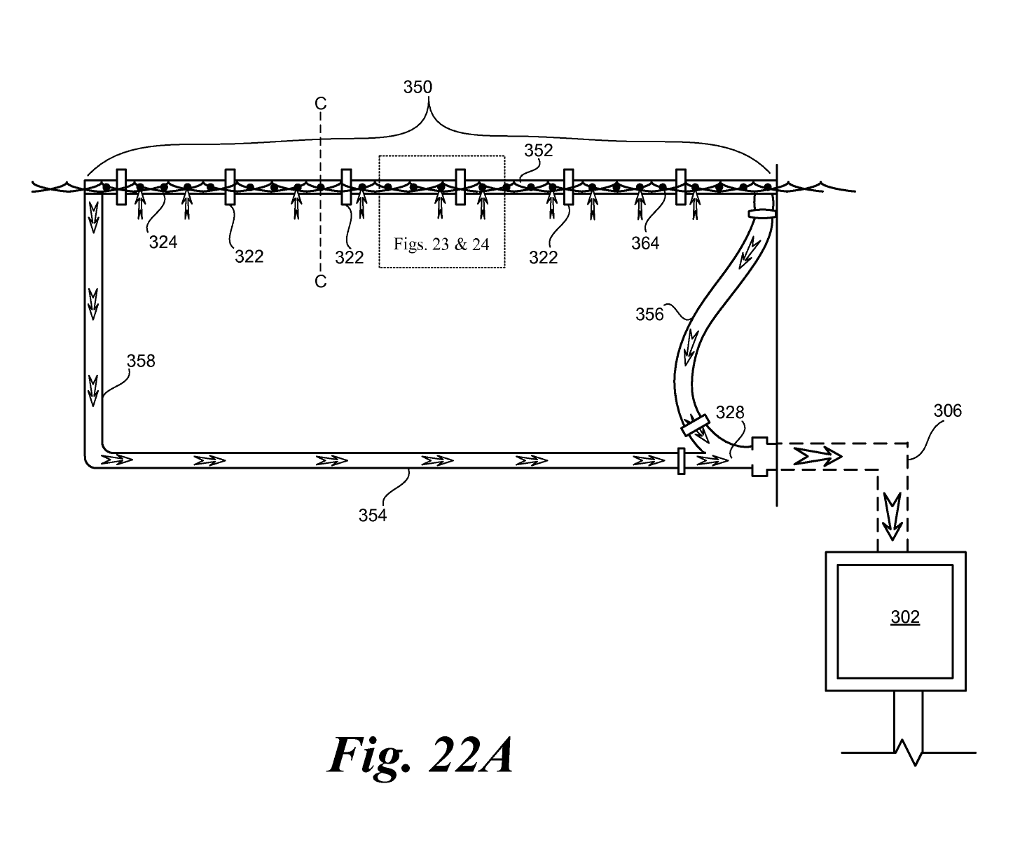

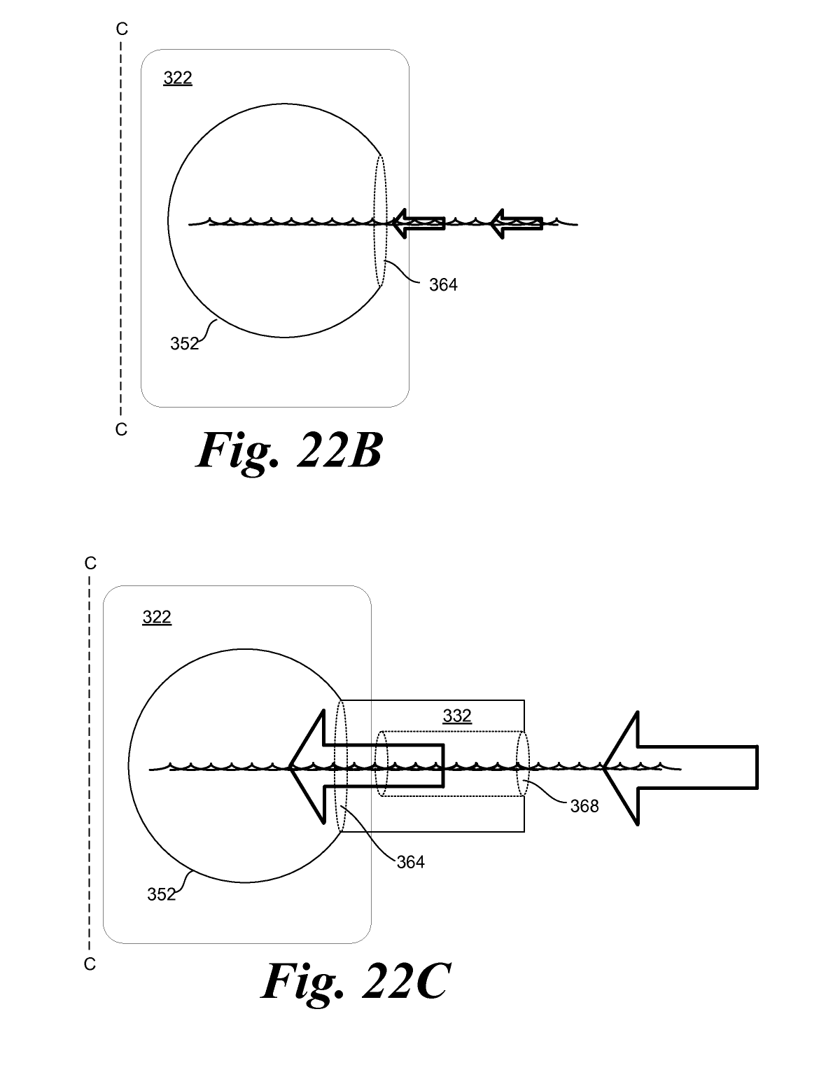

FIG. 22A schematically illustrates a side view of the negative hydraulic loop 350 of the tanker ship oil spill containment system 300 distributed on another side or a different location within the large vessel L.V. berth relative to the placement of the flexible outflow pipe 312 of the positive hydraulic loop 310. The floatable inflow pipe 352 having the multiple inflow apertures 364 is configured to be bendable to allow the adaptive corralling of oil slicks within the large vessel berth and their subsequent suction into the internal lumen of the inflow pipe 352 and subsequent delivery to the collection pipe 354 via the proximal 356 and distal 358 pipes connected between the inflow pipe 352 and collection pipe 354. From the collection pipe 354, pollutants or oil containing water is routed to lower pressure or suction side of the high capacity pump 44 of the oil and/or other pollutant removal by the purification system 302 to produce cleansed water to the outflow pipe 304 hydraulically connected with the floatable outflow pipe 312. The bendable nature of the floatable inflow pipe 352 allows for adjusting the curvature of the pipe 352 to match or to conform more closely to the shape of that portion of the pollutant slick to which inflowing streams from the inflow apertures 364 are directed.

FIG. 22B schematically illustrates a cross-sectional view along line C-C of pipe 352 of the negative hydraulic loop 350. Here the parabolic apex 379 of the inflow aperture 364 is bisected by the surface water depicted as waves. The large directional flow arrow signifies the substantially horizontal direction of the polluted water streams at or near the surface water layer holding the pollutant slick. Behind the cross-section of the outflow pipe 352 is the float 322.

FIG. 22C schematically illustrates a cross-sectional and side view along line C-C of FIG. 22A of the aperture 364 fitted with an inwardly directed water jet 332 to produce an enhanced suction force at a smaller inflow aperture 368. The inwardly directed flow arrow depicted in FIG. 22C is larger to designate a larger or enhanced suction force applied through the smaller inflow aperture 368 as compared to the smaller suction force designated by the smaller inwardly directed flow arrow incident to the larger inflow aperture 364 depicted in FIG. 22B. The inwardly directed water jet 332 may be configured with turbines (not shown) powered with electric motors (not shown) to increase the inwardly directed flow rates and suction forces applied to the sides of a nearby pollutant slick.

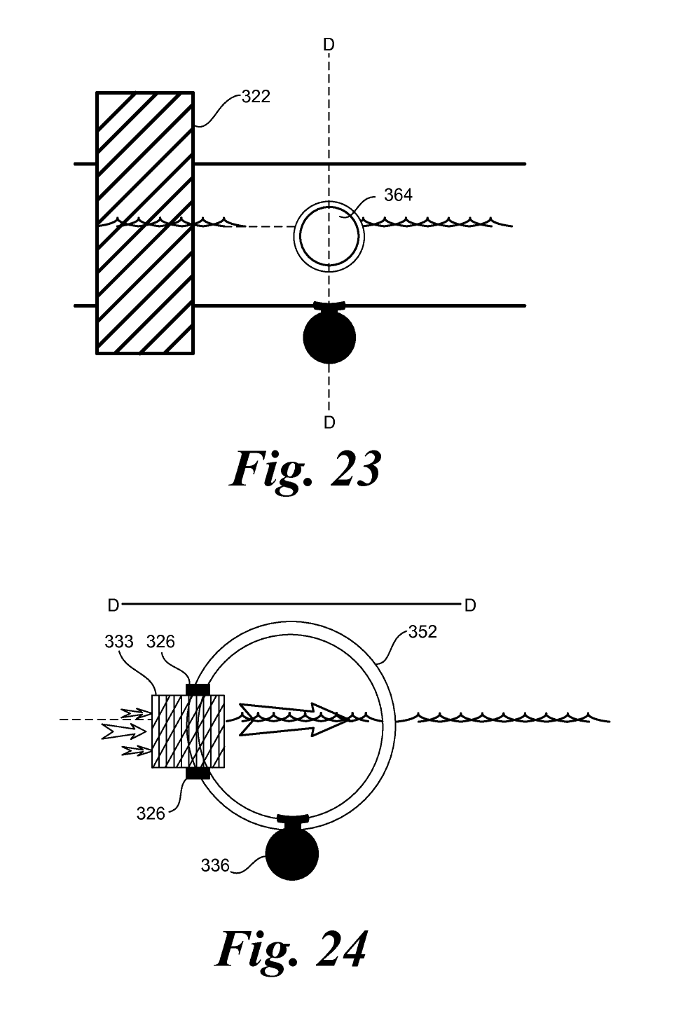

FIG. 23 schematically illustrates a side view of the negative floating boom or floating inflow pipe 352 of the negative hydraulic loop 350. More than one weight 336 may be distributed along the length of the floating pipe 352 beneath the waterline to stabilize its placement from action-reaction forces arising from suction or aspiration action conveyed through the inflow apertures 364.

FIG. 24 schematically illustrates a cross-sectional view along line D-D of FIG. 23 through the aspiration aperture 364 fitted with a water scoop 333 of the negative floating boom or floating inflow pipe 352 of the negative hydraulic loop 350. The water scoop 333 has a funnel shape to provide an angular spread to distribute suction forces from the aperture 364 to draw in water surfaces containing oil or other pollutant slicks floating on or nearby the waterline. Alternatively the aperture 364 may be fitted with an inwardly directed water jet 332 to maximize or otherwise enhance suction forces.

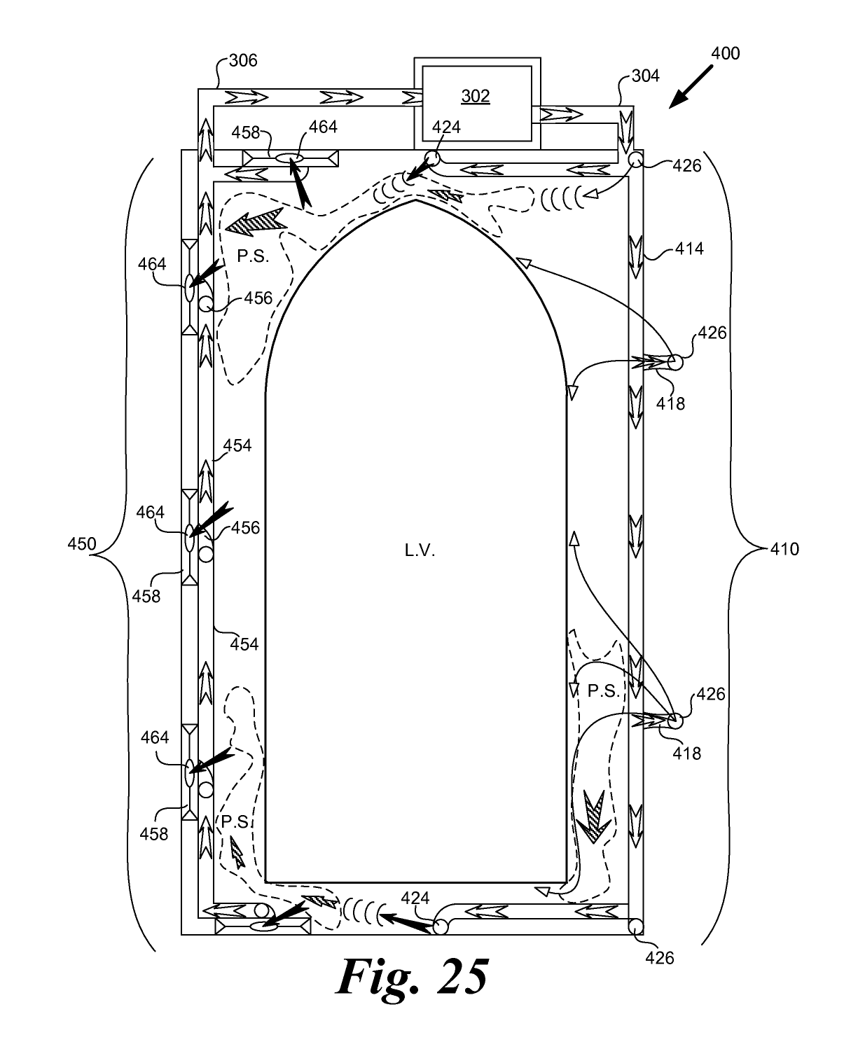

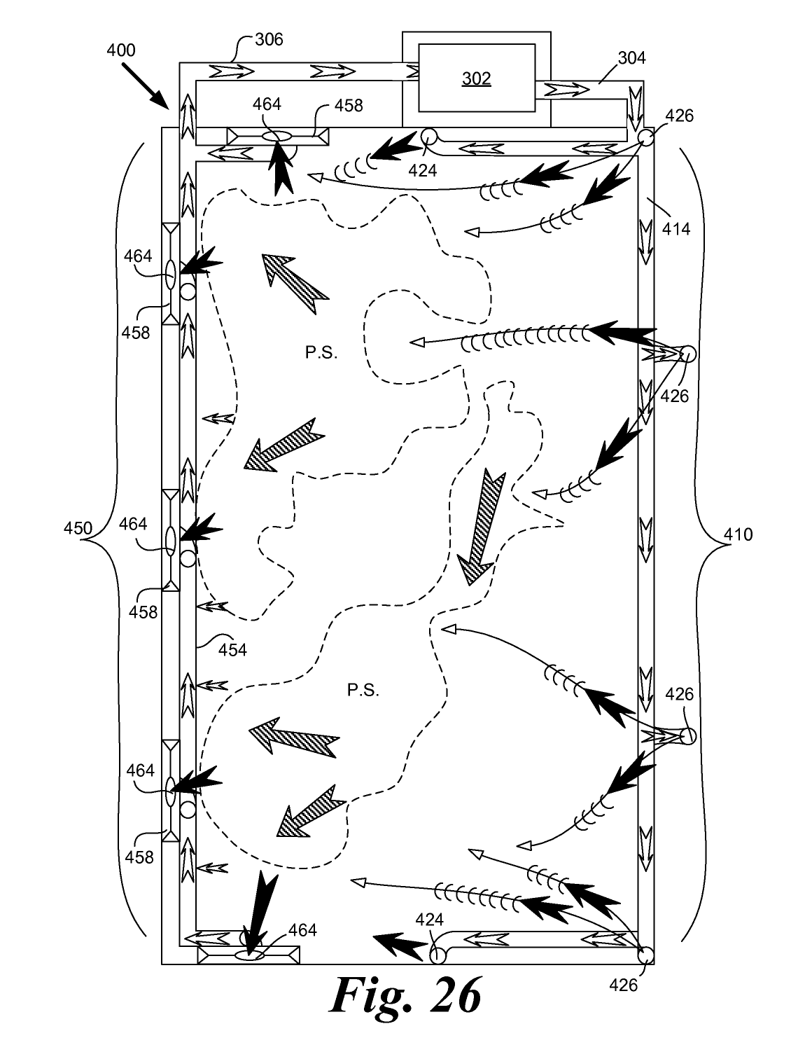

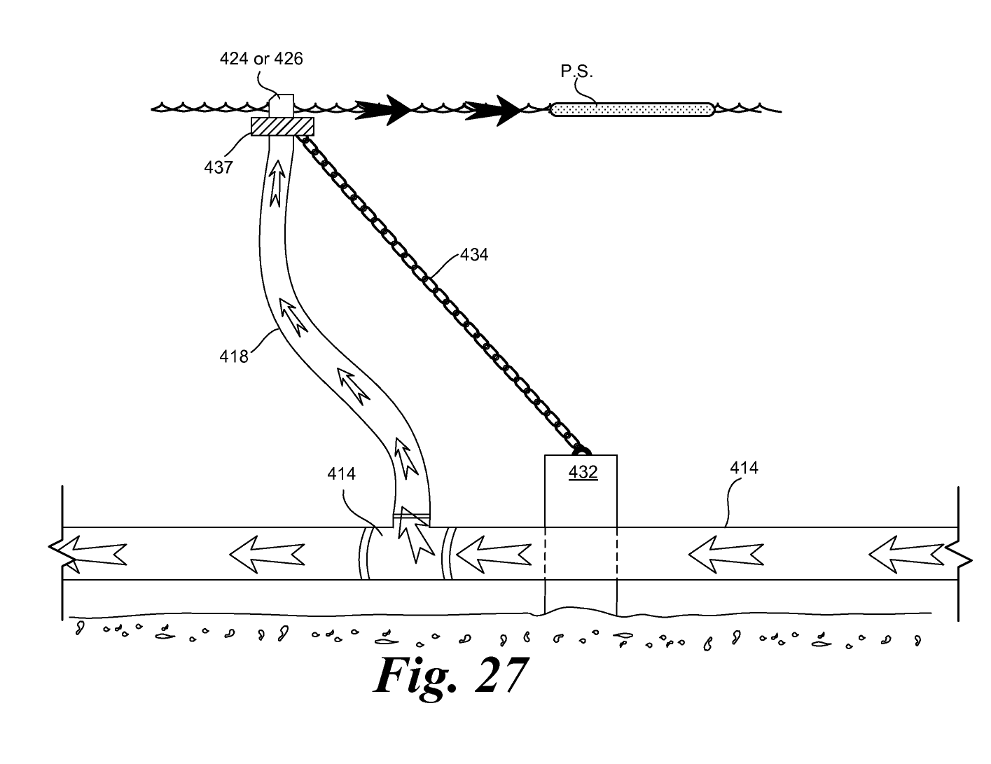

FIG. 25 schematically illustrates a top view of an alternate embodiment of a tanker ship oil spill containment system 400 showing exemplary surface water flow patterns in a boat slip berthed with a large oil tanker ship or other large vessel capable of leaking oil or other pollutants floating on the water surface or occupying regions near the waterline. Substantially similar to the spill containment system 300, the spill containment system 400 includes a positive flow hydraulic distributor 410 and negative pressure hydraulic distributor 450 in which separate floatable member radiate from submersible pipes respectively connected to the low pressure and high pressure sides of the purification system 302 previously described above. Polluted water is drawn in as indicated by the directional arrow by water scoops 458 having inflow apertures 464 occupy at various intervals along the waterline in the berth having a large vessel L.V. A submersible collector pipe 454 conveys polluted water to the low or negative pressure side of the pump 44 (not shown) in the purification system 302. Shown with dashed lines are perimeters of pollutant slicks P.S. that respond to suction pulling and outflow pushing forces that circumnavigate the berthed large vessel. The water scoops are shown connected to the submersible collection pipe 454 via connector pipes 456. The positive flow hydraulic distributor 410 includes water jets 426 receiving cleansed water from the high pressure side of the purification system 302 via outflow pipe 304 connected with a submersible delivery pipe 414. The water jets 426 are shown connected to the submerged delivery pipe 414 via connector pipes 418. Diagonal filled arrows indicate the net leftward travelling motion of the pollutant slicks P.S. around the large vessel L.V. in response to the combined pulling and pushing forces of water flows caused by the suction forces (black flow arrows pointing into inflow apertures 464) conveyed by the inflow apertures 464 and pushing forces (black flow arrows) of the water jets 424,426.

FIG. 26 schematically illustrates a top view of the positive pressure hydraulic distributor 410 and negative pressure hydraulic loop 450 of the tanker ship oil spill containment system 400 showing exemplary surface water flow patterns in the boat slip without the large oil tanker ship being present. Pollutant slicks P.S. are shown clustering against the water scoops 458 for aspirating into inflow apertures 464 in response to the pulling forces generated by the suction action as indicated by the black-filed directional flow arrows pointing into the inflow apertures 464 and the additive pushing forces generated by the water jets 426 from the out flowing streams emanating from the water jets 424,426 also designated by the black filed flow directional arrows. Diagonal filled arrows indicate the net leftward travelling motion of the pollutant slicks P.S. in response to the combined pulling and pushing forces of water flows caused by the suction forces conveyed by the inflow apertures 464 and pushing forces of the water jets 424,426.

FIG. 27 schematically illustrates a side view of a floating jet head 424 or 426 hydraulically connected with the positive pressure hydraulic distributor 410 of FIGS. 25 and 25 via the delivery pipe 414. From the submerged delivery pipe 414 the flexibly configurable connector pipe 418 is shown secured to anchor block 432 via chain tether 434 connected to the anchor block 432 and float collar 437 that keeps the outwardly flowing streams emanating from the jet head 424 substantially along the waterline as indicated by the black-filled directional arrows. Alternatively, a two-headed jet head 426 above the water jets 424 shown in FIGS. 24 and 25. The two-headed jet head 426 may be fitted to be supported by the float collar 437 and provides two separate streams. One of the streams is shown pushing a pollutant slick P.S. floating on the surface indicated by dotted interior. The out flowing water emanating from the single 424 or the two-headed flow jet 426 as indicated by the black-filled flow arrow shown pushing against one side of the floating oil or pollutant slick P.S. Beneath the surface located on the seafloor or marina floor bottom is anchor block 432 shown adjacent to and behind submerged pipe 414.

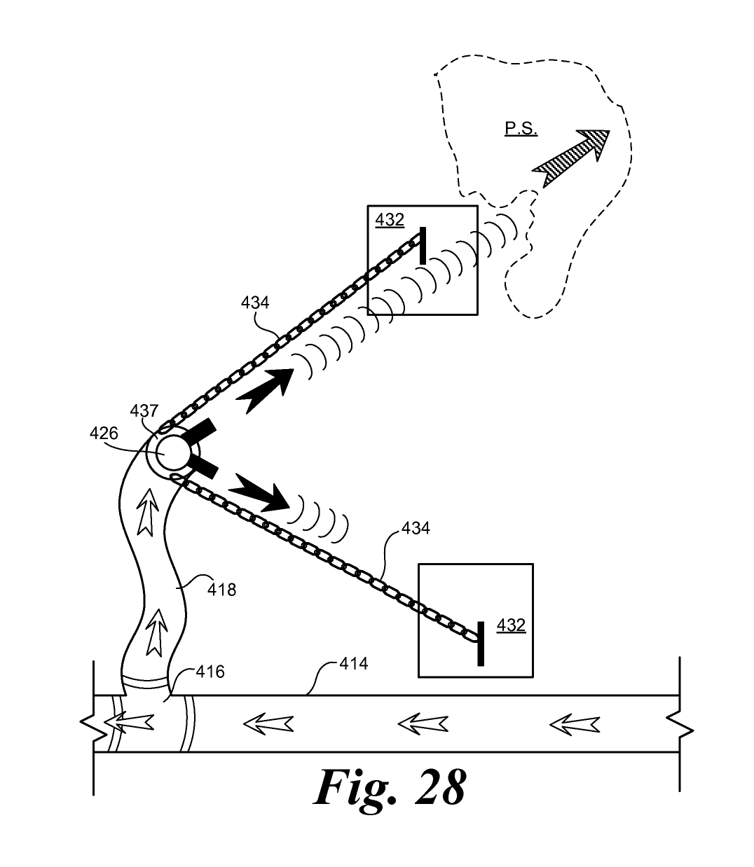

FIG. 28 schematically illustrates a top view of the two-headed floating jet 426 hydraulically connected with the positive pressure hydraulic distributor 410. Anchor blocks 432 are shown at the seafloor or berth space bottom, each having a chain tether 434 connected to the anchor block 432 and float collar 437. The black flow directional arrows indicate the vector directional push of water stream emerging from each water jet of the two-headed floating jet 426 at or near the water surface. The hollow flow arrows indicate flow within the submerged delivery pipe 414 located near the berth's bottom and connector pipe 418 connecting the delivery pipe 414 to the two-headed floating jet 426. One of the streams is shown pushing a pollutant slick P.S. floating on the surface indicated by the diagonally hatched flow arrow in response to the pushing force conveyed to the P.S by the outwardly flowing water emanating from the jet head 426. Beneath the surface located on the seafloor or marina floor bottom is anchor blocks 432, one being adjacent to the submerged pipe 414.

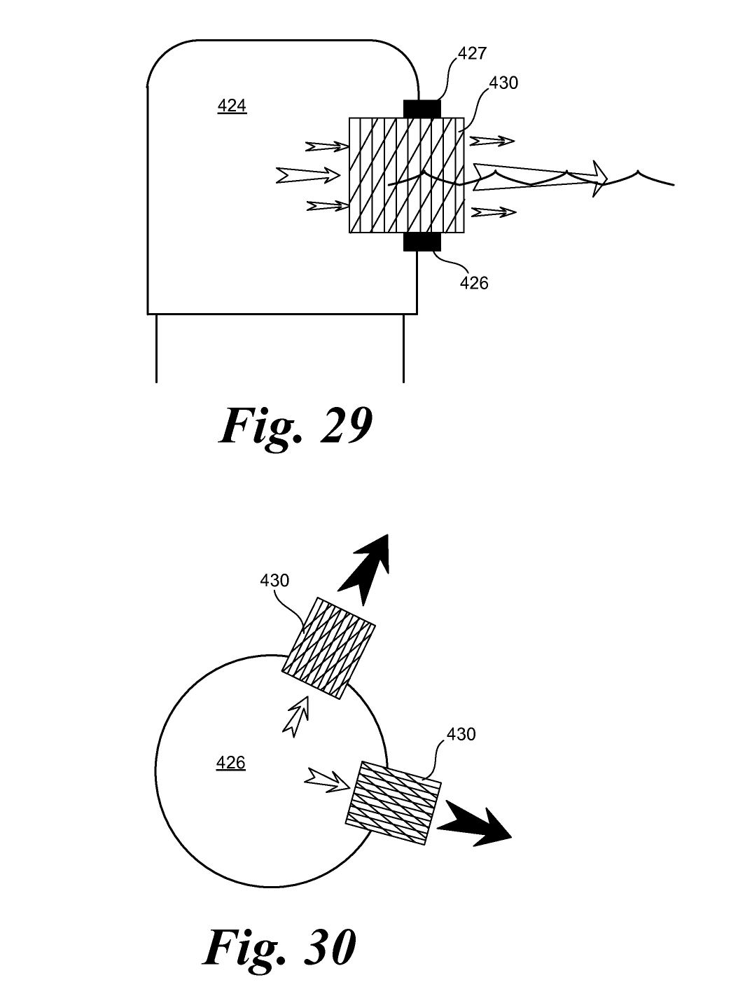

FIG. 29 schematically illustrates a side view of a single nozzle 430 adapted to the floating jet 424. An increased hydraulic thrust or force to the outflow streams emerging from the nozzle 430 is provided substantially at the water line against an oil or other pollutant slick floating on or closely nearby the water surface. The nozzle 430 may include variable constrictions or insertable constrictors to variably or incrementally increase the thrusting of outflow streams from the nozzle 430.

FIG. 30 schematically illustrates a top view of double nozzle floating jet head 426. Two nozzles separated by an acute angle provide an increased angular coverage to provide boosted thrust to emerging outflow streams directed substantially horizontally along the water line.

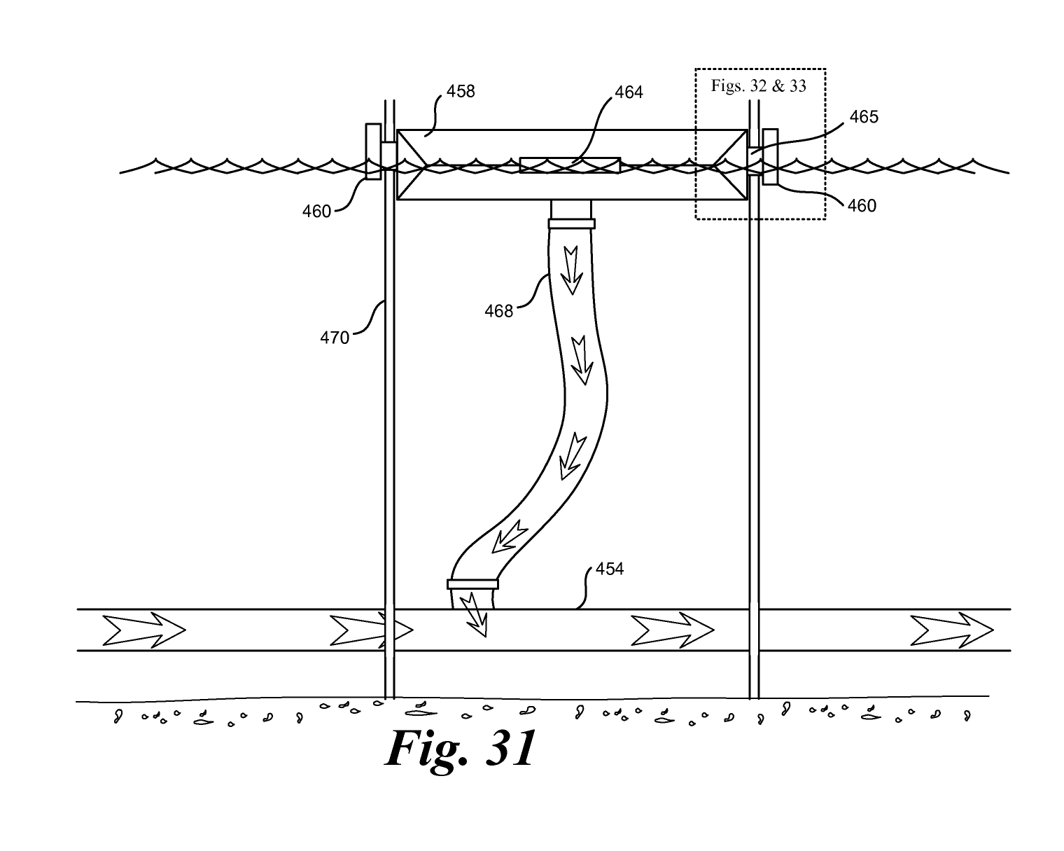

FIG. 31 schematically illustrates a side view of a floating vacuum scoop 458 hydraulically connected with the negative pressure hydraulic loop 450. The water scoop 458 provides a funneled configuration to the inflow aperture 464 located along the water line as indicated by the surface water wave pattern. Suction forces are provided by submerged collector pipe 454 that is conveyed to the inflow aperture 464 of the floatable water scoop 458 via the flexibly configurable connection pipe 468. The floating vacuum scoop 458 is vertically kept near the waterline by side floats 460 attached to and restricted from horizontal deflection by poles 470 via sliders 465 attached to the side portions of the water scoop 458 and the side floats 460. The sliders 465 slidably engageable in the vertical direction with the poles 470 in response to the changes in the vertical height of the water surface as conveyed by side floats 460. The poles 470 may be secured against a dockside structure (not shown) or may extend to the bottom of the large vessel berth.

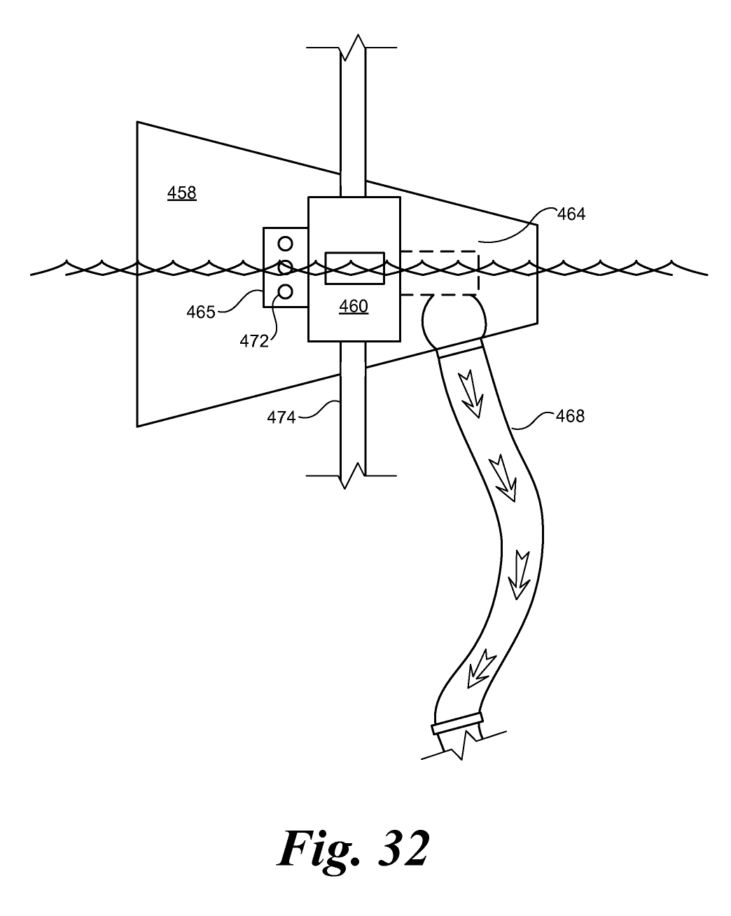

FIG. 32 schematically illustrates a side cross-sectional view of the floating vacuum scoop 458. Flexible connection tube 468 is attached to the bottom portion of inflow aperture 464. Slider 465 is connected with the side float 460 and bolts 472 secure the slider 465 to the water scoop 458. The side float 460 rises or falls with the water level to allow the slider 465 to slidably engage in vertical movement with the tube 470 to maintain the inflow aperture 464 close to the waterline.

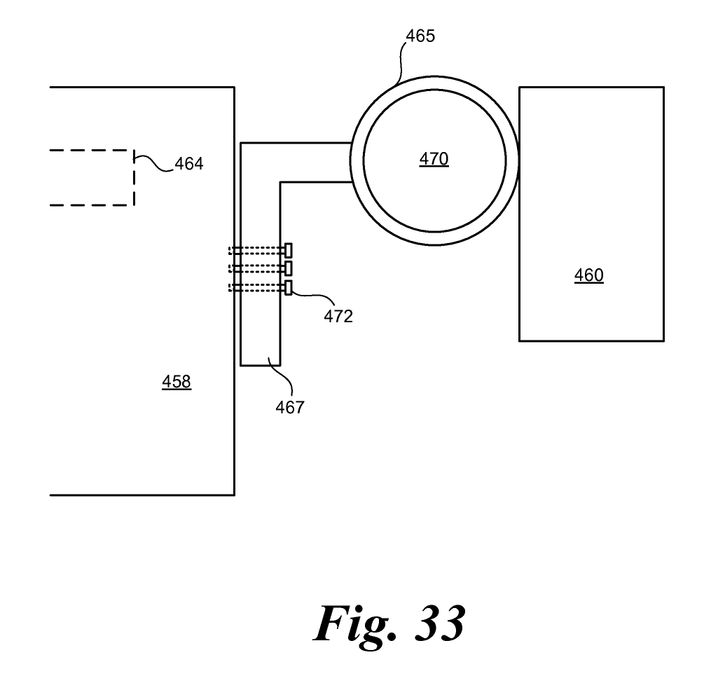

FIG. 33 schematically illustrates a top view of a portion of the floating vacuum scoop 458. Slider 465, connected to the vacuum scoop 458 via bolts 472 penetrating through arm 467, secures the vacuum scoop 458 to the side float 460 and allows vertical motion arising from the slidable engagement with the pole 470. The up and down forces conveyed by side float 460 maintain the inflow aperture 464 near the waterline.

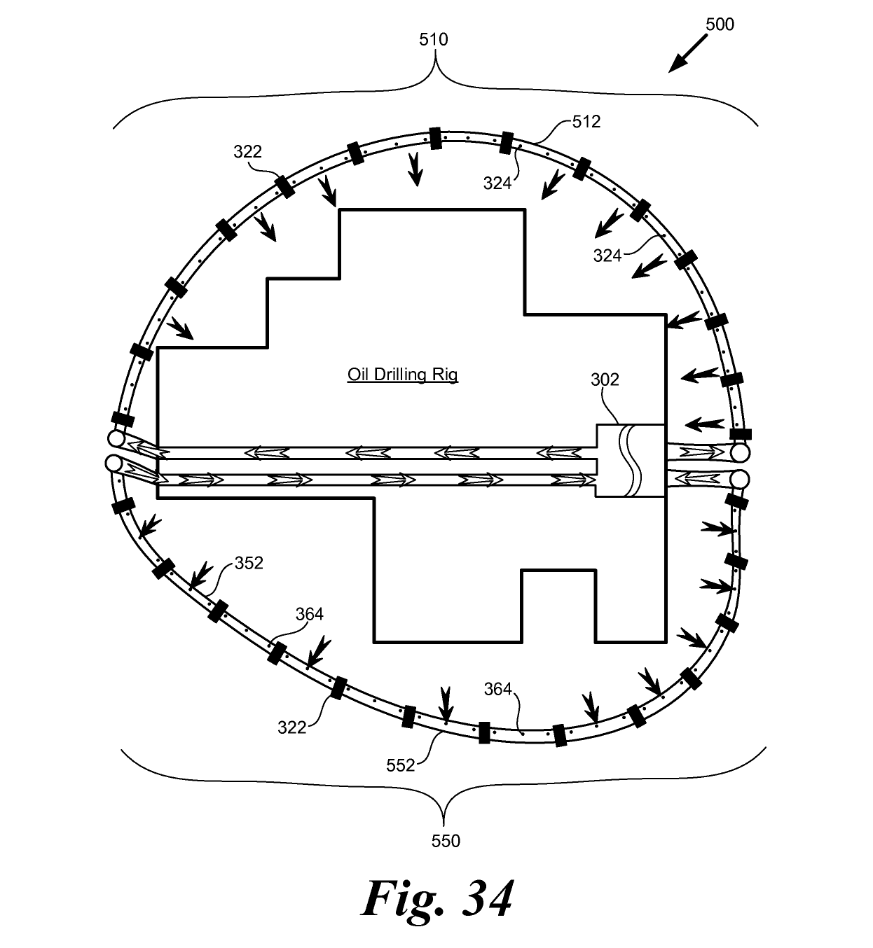

FIG. 34 schematically illustrates a top view of an alternate embodiment of an oil rig platform spill containment system 500. The rig-based containment system 500 operates similarly to the spill containment system in that a positive hydraulic distributor 510 cooperatively works with a negative hydraulic distributor 550 to lasso or corral drilling rig oil leaks. The positive hydraulic distributor 510 includes a flexible outflow pipe 612 equipped with a plurality of outflow apertures 324 shown in a series arrangement. The outflow apertures 324 may also be adapted with outwardly flowing water jets 330 (not shown). The negative hydraulic distributor 550 includes a flexible inflow pipe 652 equipped with a plurality of inflow apertures 354 shown in a series arrangement. The inflow apertures 354 may also be adapted with inwardly flowing water jets 330 (not shown). The purification system 302 operates on the rig to separate oil from water and return cleansed water to region of water corralled via outflow apertures 324 of flexible outflow pipe 512 placed near the waterline and adjusted to at least partially encircle one side or one portion of an oil slick or pollutant slick. Similarly, oil slick containing water is aspirated by inflow apertures 364 aspirating at or near surface layer water into the flexible inflow pipe 552 similarly positioned on the other side of any floating pollutant slicks present in the vicinity of the oil drilling rig. The flexible outflow 512 and inflow 552 pipes are supported by multiple flotation devices 322 distributed in intervals along the respective lengths of pipes 512/552. Aspirated pollutant slicks are conveyed to the rig mounted purification system 302. Oil is separated from the incoming water containing the pollutant slicks and cleansed water is sent to the positive hydraulic distributor 510 for delivery of restored water to the water region occupying the vicinity of the oil drilling rig.

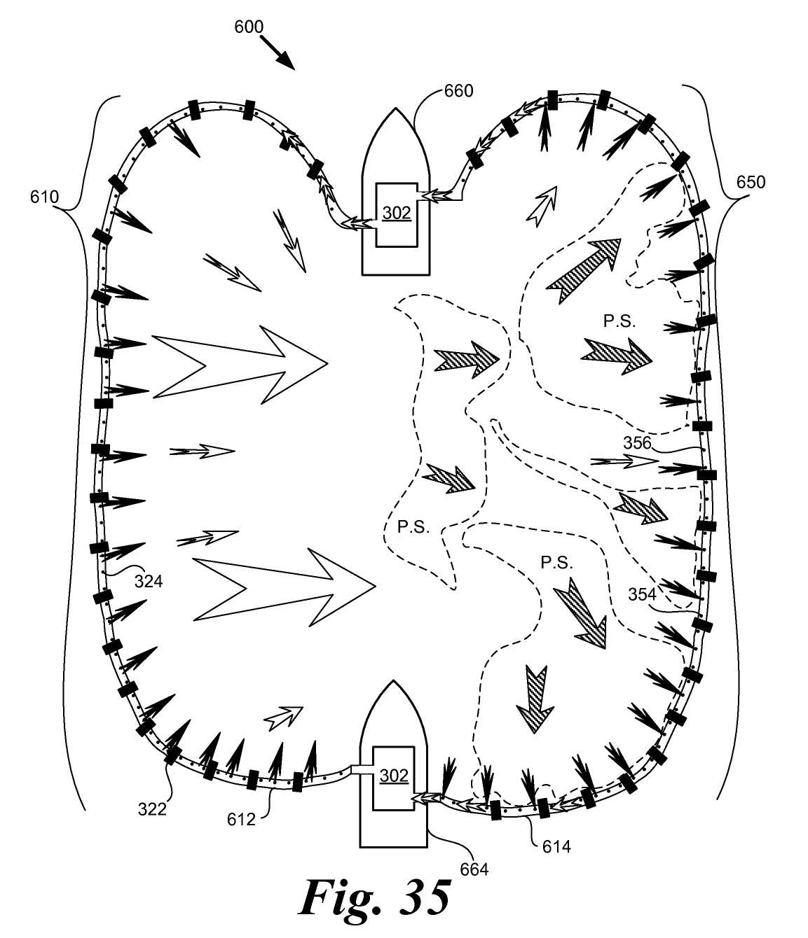

FIG. 35 schematically illustrates a top view of an alternate embodiment of a multiple ship deployed spill containment system 600. Similar to the drilling rig platform spill containment system 500, system 600 utilizes two water purifications systems 302, where one water purification system resides on a first ship 660 and the other purification system 302 resides on a second ship 664. The ships 660,664 cooperatively work together to provide a platform basis to erect a positive hydraulic distributor 610 and a negative hydraulic distributor 650 erected between ships 660,664 to lasso or corral oil or pollutant slicks P.S. A floatable outflow pipe 612 is placed to span across the space on one side of the pollutant slicks P.S between the ships 660,664 in which the ends of the outflow pipe 612 is connected to the positive pressure ends of the purification systems 302 on the respective first and second ship 610 and 614. Similarly, the floatable inflow pipe 614 is placed to span across the space on the other side of the pollutant slicks P.S. between the ships 660,664 in which the ends of the inflow pipe 614 are connected to the negative pressure end of the purification systems 302 on the respective first and second ship 660 and 664. The outflow pipe 612 and inflow pipe 614 can be flexibly shaped to a contour suitable to effectively lasso the pollutant slicks and minimize their travelling distance and time to be aspirated from the corralled area and processed by the purification systems 302 to remove oil and return cleansed water to the corralled region of water. Large flow directional arrows illustrate the polarity of the high pressure side to the low pressure side of the contained oil or pollutant slicks. The positive hydraulic surface flow vector from the outflow apertures 324 water streams and directionally merges with the aspiration fluid flows into the inflow apertures 354 to provide a net water surface movement to cause the migration of the pollutant slicks towards the floating inflow pipe 614.

While the particular embodiments have been illustrated and described removing polluted water and returning pollutant removed or restored water to the water pools or the water regions of substantially rectangular configured marinas, other embodiments are possible. For example, other plumbing arrangements within the purification system 302 illustrated in FIG. 17 besides series connections are possible. Such plumbing configurations could include splitting the oil separator 48 into a stack of parallel plumbing arrangements (not shown), wherein each flow path of the oil separator stack (not shown) includes a valving network (not shown) that may be routed around the micro-filter 52 and/or aerator 56 to increase flow capacity of clarified water to the out flow pipe 304 should periods having high volume demands requiring volume shunting procedures. In view of the above, the embodiments of the invention should be determined entirely by reference to the claims that follow.

The embodiments of the invention in which an exclusive property or privilege is claimed are defined as follows:

1. A method for removing a pollutant slick from a region of water comprising:
positioning at least one positive flow source on a first side of the pollutant slick near the water surface adjacent to the first side;
positioning at least one negative flow source on a second side of the pollutant slick near the water surface adjacent to the second side;
emanating a first water flow from the at least one positive flow source towards the first side to move the pollutant slick towards the at least one negative flow source;
aspirating a second water flow adjacent to the second side into the at least one negative flow source to move the pollutant slick towards the at least one negative flow source;
separating pollutants from the second water flow having at least a portion of the pollutant slick to form a cleansed water; and
merging the cleansed water with the first water flow.

2. The method of claim 1, wherein emanating the first water flow includes directing the first water flow towards the first side of the pollutant slick via a water jet hydraulically coupled to the positive pressure side of a water pump.

3. The method of claim 1, wherein aspirating the second water flow includes applying hydraulic suction to a water scoop placed near the second side of the pollutant slick via a water scoop hydraulically coupled to the negative pressure side of the water pump.

4. The method of claim 1, wherein positioning the at least one positive flow source is orthogonal to the at least one negative flow source.

5. The method of claim 1, wherein positioning the at least one positive flow source is diagonal to the at least one negative flow source.

6. The method of claim 1, wherein positioning the at least one positive flow source includes connecting the at least one positive flow source to a first plumbing network connected to a positive pressure side of a hydraulic pump.

7. The method of claim 1, wherein positioning the at least one positive flow source includes connecting the at least one positive flow source to a floatable first plumbing network connected to a positive pressure side of a hydraulic pump.

8. The method of claim 7, wherein connecting the at least one positive flow source to the floatable first plumbing network includes connecting to at least one single-headed water jet separately connected to the positive pressure side of the hydraulic pump.

9. The method of claim 7, wherein connecting the at least one positive flow source to the floatable first plumbing network includes connecting to at least one double-headed water jet separately connected to the positive pressure side of the hydraulic pump.

10. The method of claim 7, wherein connecting the at least one positive flow source to the floatable first plumbing network includes connecting to an array of water jets connected to the positive pressure side of the hydraulic pump.

11. The method of claim 7, wherein connecting to an array of water jets includes connecting to a plurality of water jets connected in series.

12. The method of claim 1, wherein positioning the at least one negative flow source includes connecting the at least one negative flow source to a second plumbing network connected to a negative pressure side of a hydraulic pump.

13. A system for removing a pollutant slick floating on or near the surface of a region of water comprising:
an hydraulic pump having a negative pressure side and a positive pressure side;
at least one water jet connected with the positive pressure side and configured to deliver a pushing water flow at or near the water surface against a first side of the pollutant slick;
at least one water aperture connected with the negative pressure side configured to aspirate water to deliver a pulling water flow at or near the water surface against a second side of the pollutant slick; and
a pollutant-water separator connected between the positive pressure side and the at least one floatable water jet, the pollutant-water separator configured to produce a cleansed water by removing oil from aspirated water having at least a portion of the pollutant slick conveyed into the at least one floatable water aperture;
wherein the cleansed water is delivered to the at least one water jet.

14. The system of claim 13, wherein the at least one water jet includes a plurality of water jets deployable from at least one of a dock, an oil rig platform, and at least one ship positioned to at least partially circumscribe the pollutant slick and configured to deliver a substantially horizontally directed pushing water flow against the first side of the pollutant slick.

15. The system of claim 13, wherein the at least one aperture includes a plurality of apertures deployable from at least one of a dock, an oil rig platform, and at least one ship positioned to at least partially circumscribe the pollutant slick and configured to deliver a substantially horizontally directed pulling water flow against the second side of the pollutant slick.

16. The system of claim 13, wherein the at least one water jet and the at least one water aperture are configured to be variably placed to each other at an angular orientation from acute to oblique from their respective first and second positions spanning the pollutant slick.

17. A system for removing a pollutant slick floating on or near the surface of a region of water comprising:
an hydraulic pump having a negative pressure side and a positive pressure side;
at least one floatable water jet connected with the positive pressure side and configured to deliver a pushing water flow at or near the water surface against a first side of the pollutant slick;
at least one floatable water aperture connected with the negative pressure side configured to aspirate water to deliver a pulling water flow at or near the water surface against a second side of the pollutant slick; and
a pollutant-water separator connected between the positive pressure side and the at least one floatable water jet, the pollutant-water separator configured to produce a cleansed water by removing oil from aspirated water having at least a portion of the pollutant slick conveyed into the at least one floatable water aperture;
wherein the cleansed water is delivered to the at least one floatable water jet.

18. The system of claim 17, wherein the at least one floatable water jet includes a plurality of water jets deployable from at least one of a dock, an oil rig platform, and at least one ship positioned to at least partially circumscribe the pollutant slick and configured to deliver a substantially horizontally directed pushing water flow against the first side of the pollutant slick.

19. The system of claim 17, wherein the at least one floatable aperture includes a plurality of apertures deployable from at least one of a dock, an oil rig platform, and at least one ship positioned to at least partially circumscribe the pollutant slick and configured to deliver a substantially horizontally directed pulling water flow against the second side of the pollutant slick.

20. The system of claim 17, wherein the at least one floatable water jet and the at least one floatable water aperture are configured to be variably placed to each other at an angular orientation from acute to oblique from their respective first and second positions spanning the pollutant slick.
